(19) United States
(12) Patent Application Publication
(10) Pub. No.: US 2017/0045542 A1
(43) Pub. Date: Feb. 16, 2017

(54) Modular Liquid Handling System

(71) Applicant: Counsyl, Inc., South San Francisco, CA (US)

(72) Inventors: Kyle Lapham, South San Francisco, CA (US); Tony Hyun Kim, South San Francisco, CA (US); Christopher Bremner, South San Francisco, CA (US)

(73) Assignee: Counsyl, Inc., South San Francisco, CA (US)

(21) Appl. No.: 15/230,394

(22) Filed: Aug. 6, 2016

Related U.S. Application Data
(60) Provisional application No. 62/203,358, filed on Aug. 10, 2015.
(60) Provisional application No. 62/218,463, filed on Sep. 14, 2015.

(51) Int. Cl. G01N 35/02; G01N 35/10; G01N 35/00

(52) U.S. Cl. CPC G01N 35/026; G01N 35/0099; G01N 35/10; G01N 35/00584; G01N 2035/0418

(57) ABSTRACT

Integrated modular liquid handling systems are described. The modular liquid handling systems may be customized for use in a variety of applications, including sample processing, assays, diagnostic analyses, and separation of biomolecules. The liquid handling systems may include a variety of integrated modules that provide functions including dispensing of liquids, aspiration of liquids, sensing of liquid parameters, and detection of signals.

### CROSS-REFERENCE TO RELATED APPLICATIONS

This application claims the benefit of U.S. Provisional Application No. 62/203,358, filed Aug. 10, 2015, and 62/218,463, filed Sep. 14, 2015, both of which are incorporated by reference herein in their entireties.

### FIELD OF THE INVENTION

The present invention relates to the field of liquid handing, in particular liquid handling systems and methods for processing of samples, detection of substances in samples, and/or conduction of assays.

### BACKGROUND

Research or diagnostic laboratories commonly process biological samples to extract target molecules, such as proteins or DNA, for further research or diagnostic purposes, or to detect substances of interest in samples. Consistent sample processing or diagnostic assays require time-intensive labor from trained technicians or the use of previously known sample processing systems, which have low sample throughput and require use of multiple devices when assays or other procedures require multiple steps.

Previously known liquid handling systems are limited in the number of samples that can be simultaneously processed, provide limited versatility for running a variety of assays or target molecule extractions or for integrating different processing steps, and generate substantial amounts of solid and liquid waste. For example, previous automated liquid handling systems are often capable of dispensing or aspirating a single liquid. Multiple operations involving different liquids or different processing steps such as dispensing and aspirating liquids, and detecting target molecules, require use of different devices, which is time and labor intensive. Additionally, previously known automated sample processing systems are often limited to specific protocols, with little ability to quickly exchange extraction chemistry or alter processing steps to fit the needs of a particular laboratory.

Previously known manual or automated sample processing systems also produce substantial solid or liquid waste, such as used pipette tips or blood extractions, which must be separately processed or disposed of at significant expense and risk of exposing workers to significant hazardous waste.

There is a need for an improved system for handling liquids associated with research or diagnostic sample processing, assays, and target molecule extractions.

### BRIEF SUMMARY OF THE INVENTION

Modular systems for liquid handling, and methods for using such systems, are provided.

In one aspect, an integrated modular system for liquid handling is provided, including: (a) a robotic system that includes (i) a platform configured to support a sample processing plate that includes a plurality of wells or a rack of sample tubes, mounted on a planar surface gantry configured for sliding the platform in a substantially horizontal planar direction (e.g. in “x” and/or “y” directions); (ii) a support for attaching at least one modular device that performs one or more function(s) related to liquid in the wells of the sample processing plate or in the sample tubes, mounted on a track configured for sliding the support in a substantially vertical direction (e.g. in “z” direction); (iii) a mechanism for slidably moving the platform relative to the least one modular device; and (iv) a mechanism for slidably moving the support along the track relative to the platform, (b) a pumping system for moving liquid into and out of the wells of the sample processing plate or into and out of sample tubes through the at least one modular device; and (c) a control system for controlling the function(s) related to liquid in the wells of the sample processing plate or in sample tubes and/or for controlling movement of the plate relative to the modular device(s).

In some embodiments, the robotic system is configurable to include a plurality of modular devices, located at different locations along the track or attached together in series with the first device in the series including a proximate surface or attachment point that is attached or fastened to the support on the track and a distal surface or attachment point attached or fastened to the second modular device in the series. Further modular devices, if any, may also attached be attached in series to a distal surface or attachment point of the second modular device. A plurality of modular devices may perform one or more functions, including but not limited to, dispensing liquid into wells of a sample processing plate or into sample tubes, transferring samples into wells of a sample processing plate or into sample tubes, aspirating liquid out of wells of a sample processing plate or out of sample tubes, sensing of liquid levels in wells of a sample processing plate or sample tubes, sensing of temperature in wells of the sample processing plate or sample tubes, detection of a signal in wells of a sample processing plate or sample tubes, and/or attraction of magnetic material such as magnetic beads in wells of a sample processing plate or in sample tubes to facilitate mixing of the magnetic material with liquid in wells of the plate or in sample tubes.

In some embodiments, the system includes a plurality of modular devices each performing a different function or configured to dispense a different type of liquid into the wells of the sample processing plate or into the sample tubes.

In some embodiments, the system includes a first modular device that is attached or fastened to the support and a second modular device attached or fastened to the first modular device, and optionally one or more additional modular device(s) attached in series to the second modular device, and the planar surface gantry is configured to move relative to the modular devices such that one or more function(s) may be performed in wells of the sample processing plate or in the sample tubes, such as, but not limited to, transferring of samples or dispensing of liquid into wells of the sample processing plate or into sample tubes, aspiration of liquid out of wells of the sample processing plate or out of sample tubes, sensing of liquid levels and/or temperature in wells of the sample processing plate or in the sample tubes, detection of a signal in wells of a sample processing plate or in sample tubes, and/or attraction of magnetic material such as magnetic beads in wells of a sample processing plate or in sample tubes to facilitate mixing of the magnetic material with liquid in wells of the plate or in the tubes.

In some embodiments, the control system controls one or more functions, such as, but not limited to, controlling liquid movement into and/or out of the wells of a sample processing plate or into sample tubes in a tube rack, sensing of liquid levels and/or temperature in the wells of a sample processing plate or in sample tubes, detection of a signal in the wells of a sample processing plate or in sample tubes, movement of a plate or tube rack relative to the modular device(s), and/or movement of modular device(s) relative to the plate or tube rack.

In some embodiments, wells of the sample processing plate or sample tubes include samples that are pre-loaded into the well or tube prior to inclusion of the plate or tube in the modular system for liquid handling.

In some embodiments, the system includes at least one modular device that is configured to dispense affinity beads in liquid into wells of the sample processing plate or into sample tubes. The affinity beads may include, for example, one or more affinity moiety that is capable of binding to a target molecule when present in a sample. In some embodiments, the affinity beads are capable of separating one or more molecule(s) or component(s) of a sample from other components of the sample. In certain embodiments, the affinity beads are magnetic. In such embodiments, the platform that supports the plate may include one or more magnet that is capable of magnetically attracting the magnetic beads, for example, magnet(s) configured underneath the wells or configured to move in interwell spaces between wells of the sample processing plate or configured underneath sample tubes or configured to move in between sample tubes in a tube rack, to pull the magnetic beads to the bottom of the wells.

In some embodiments, liquid samples are transferred into wells of the sample processing plate or into sample tubes in a tube rack from external sample containers, and the system includes a modular device that is a sample transferring module, for example, including a pipetting mechanism that is fluidly connected to each sample container. In such an embodiment, the pumping system may be configured to transfer a predetermined amount of liquid sample from a sample container into a well of the sample processing plate or into a sample tube. In some embodiments, prior to transferring samples into wells of the plate or into sample tubes, the wells or tubes are pre-coated with one or more reagent or affinity moiety that is capable of reacting with or binding to a target molecule when present in a sample. In some embodiments, prior to transferring samples into wells of the plate or into sample tubes, the wells or tubes include affinity beads that include one or more affinity moiety that is capable of binding to a target molecule when present in a sample. In some embodiments, the affinity beads are capable of separating one or more molecule(s) or component(s) of a sample from other components of the sample. In certain embodiments, the affinity beads are magnetic. In such embodiments, the platform that supports the plate may include one or more magnet that is capable of magnetically attracting the magnetic beads, for example, magnet(s) configured underneath the wells or configured to move in interwell spaces between wells of the sample processing plate or configured underneath sample tubes or configured to move in between sample tubes in a tube rack, to pull the magnetic beads to the bottom of the wells.

In some embodiments, the system includes at least one modular device for dispensing liquid, and further includes an external liquid reservoir that is fluidly connected to the liquid dispensing module, and the liquid dispensing module is configured for dispensing liquid from the external reservoir into wells of the sample processing plate or into sample tubes in a tube rack. In some embodiments, the external liquid reservoir is fluidly connected to an internal liquid reservoir within the liquid dispensing module, the pumping system is configured to pump liquid from the external liquid reservoir into the internal liquid reservoir, and a predetermined amount of liquid is pumped from the internal liquid reservoir into wells of the plate or into the sample tubes when the system and the liquid dispensing module are in operation. In some embodiments, the liquid dispensing module includes a plurality of dispensing nozzles that are configured to dispense liquid into wells of the plate or into sample tubes. In certain embodiments, the dispensing nozzles comprise, consist of, or consist essentially of plastic, for example, but not limited to polyether ether ketone (PEEK) and/or polycarbonate. In some embodiments, the dispensing of liquid into wells of the plate or into sample tubes is contactless.

In some embodiments, the system includes at least one modular device for dispensing liquid that includes a plurality of dispensing nozzles that are configured to dispense liquid into wells of the sample processing plate or into sample tubes in a tube rack, wherein the liquid dispensing module is fluidly connected to at least a first liquid reservoir and a second liquid reservoir, wherein the first liquid reservoir includes a reagent for dispensing into wells of the plate or into sample tubes and the second liquid reservoir includes water or a solvent for removing salt or other unwanted substances from the nozzles of the dispensing module when liquid from the second liquid reservoir is dispensed through the nozzles. In some embodiments, the liquid dispensing module is fluidly connected to a waste disposal system, and liquid from the second external liquid reservoir that is dispensed through the nozzles of the dispensing module is conducted to the waste disposal system.

In some embodiments, the system includes a plurality of first external liquid reservoirs that include different liquids and a plurality of liquid dispensing modules, wherein each first external liquid reservoir is fluidly connected to a different liquid dispensing module. In some embodiments, at least one of the liquids includes affinity beads that include one or more affinity moiety that is capable of binding to a target molecule when present in a sample. In some embodiments, the affinity beads are capable of separating one or more molecule(s) or component(s) of a sample from other components of the sample. In certain embodiments, the affinity beads are magnetic. In such embodiments, the platform that supports the plate may include one or more magnet that is capable of magnetically attracting the magnetic beads, for example, magnet(s) configured underneath the wells or configured to move in interwell spaces between wells of the sample processing plate or configured underneath sample tubes or configured to move in between sample tubes in a tube rack, to pull the magnetic beads to the bottom of the wells. In some embodiments, at least one of the plurality of liquid dispensing modules is fluidly connected to a second external liquid reservoir, wherein the first external liquid reservoir includes a reagent for dispensing into wells of the sample processing plate or into sample tubes and the second external liquid reservoir comprises water or a solvent for removing salt or other unwanted substances from the nozzles of the dispensing module when the liquid in the second external liquid reservoir is dispensed through the nozzles.

In some embodiments, the system includes at least one modular device for aspirating liquid, configured to remove liquid from the wells of the plate. In some embodiments, the aspiration module includes a plurality of aspiration nozzles, wherein each nozzle is configured to aspirate liquid from a well of the plate. In some embodiments, the aspiration module is fluidly connected to a waste disposal system, and liquid that is aspirated from the wells of the plate is conducted to the waste disposal system. In some embodiments, the aspiration nozzles are composed of biocompatible plastic, such as, but not limited to, PEEK. In some embodiments, the aspiration nozzles are composed of Teflon®-coated metal.

In some embodiments, the system includes at least one modular device with one or more sensor(s) for sensing a parameter in wells of the sample processing plate or in sample tubes, for example, but not limited to, liquid level and/or temperature.

In some embodiments, the system includes at least one modular device for detection of a signal in wells of the sample processing plate or in sample tubes, for example, but not limited to, a light absorbance signal, a fluorescence signal, or a luminescence signal.

In some embodiments, the system includes at least one modular device that includes a vision system. For example, a vision system may detect at least one feature, such as, but not limited to, presence or absence of contamination in a sample, ring formation of magnetic beads, liquid level, separation of cell layers in centrifuged blood, a 1-D or 2-D barcode on a tube or plate, presence of liquid on the side of a tube or well, patient information written on a tube or plate, tube or plate type, presence or absence of a tube cap or plate seal, presence or absence of sample in a tube or well, and/or bubbles in a tube or well.

In some embodiments, the system includes at least one modular device that dispenses liquid and at least one modular device that aspirates liquid. In some embodiments, the system includes at least one modular device that dispenses liquid, at least one modular device that aspirates liquid, and at least one modular device that senses a parameter in wells of the sample processing plate or in sample tubes. In some embodiments, the system includes at least one modular device that dispenses liquid, at least one modular device that aspirates liquid, and at least one modular device that detects a signal in wells of the sample processing plate or in sample tubes. In some embodiments, the system includes at least one modular device that dispenses liquid, at least one modular device that aspirates liquid, and at least one modular device that senses a parameter in wells of the sample processing plate or in sample tubes, and at least one modular device that detects a signal in wells of the sample processing plate or in sample tubes.

In some embodiments, the system includes at least one modular device that includes a magnet (such as, but not limited to, a bar magnet). For example, the magnet may attract magnetic beads in the wells of a plate when the wells pass underneath the magnet, providing mixing of the beads in the wells without physical agitation of the plate. The planar surface gantry may be configured and controlled to move the sample processing plate underneath the magnet to facilitate such mixing of the magnetic beads in the wells.

In some embodiments of the integrated modular systems for liquid handling described herein, the platform that supports the plate is capable of providing one or more functionalities in relation to the plate supported thereon, including, but not limited to, shaking, heating, cooling, magnetic attraction of magnetic material in wells of the plate, and magnetic contactless mixing. In some embodiments, the platform that supports the plate includes a tip-tilt mechanism.

In some embodiments of the integrated modular systems for liquid handling described herein, the pumping system includes at least one diaphragm pump.

In some embodiments of the integrated modular systems for liquid handling described herein, the control system controls the sequencing of functions performed by a plurality of modular devices, such as, but not limited to, transferring of samples into wells of a sample processing plate or into sample tubes, dispensing of liquid into wells of a sample processing plate or into sample tubes, attraction of magnetic material such as magnetic beads in wells of a sample processing plate or in sample tubes to facilitate mixing of the magnetic material with liquid in wells of the plate, aspiration of liquid out of wells of a sample processing plate or out of a sample tube, sensing of liquid levels in wells of a sample processing plate or in sample tubes, sensing of temperature in wells of a sample processing plate or in sample tubes, and/or detection of a signal in wells of a sample processing plate or in sample tubes.

In another aspect, methods of use of the integrated modular liquid handling systems described herein are provided. In some embodiments, an integrated modular liquid handling method includes transferring a plurality of samples from a plurality of sample containers into wells of a sample processing plate that includes a plurality of wells or into sample tubes in a tube rack, wherein each sample is transferred into a different well or sample tube; dispensing liquids into the plurality of wells of the plate or into sample tubes using a liquid dispensing module, e.g., a contactless liquid dispensing device; detecting the liquid level in each of the plurality of wells of the plate or in each sample tube using a plurality of liquid level sensors, e.g., contactless liquid level sensors; attracting magnetic material such as magnetic beads in wells of a plate or in sample tubes, thereby facilitating mixing of the magnetic material with liquid in wells of the plate; aspirating liquid from the plurality of wells of the plate or from the sample tubes using a plurality of aspirators; managing liquids removed from the plurality of wells or sample tubes using a waste management system; and/or detecting a signal in wells of the plate or in sample tubes, using an integrated modular liquid handling system as described herein for all of these operations.

In some embodiments, a plurality of samples is analyzed or one or more target molecule(s) extracted from each sample. In some embodiments, the plurality of samples includes blood or saliva. In some embodiments, method includes extraction of DNA from the plurality of samples using magnetic beads.

In some embodiments, liquid level sensors are deployed. Any suitable liquid level sensor may be used, including, but not limited to, one or more acoustic sensors, one or more weight sensors, one or more pressure sensor, and/or one or more laser sensors.

In some embodiments, a waste management system deposits the liquids removed from the plurality of wells or sample tubes into a waste container. In some embodiments, the waste container operates under a vacuum. A series of valves may be included to ensure the proper operation of vacuum. In some embodiments the waste is removed using gravity. In some embodiments, the waste management system mixes the liquids removed from the plurality of wells or sample tubes with bleach or another sterilization solution in the waste container and incubates the mixture. In some embodiments, the waste management system includes one or more sensors for determining an amount of liquid removed from the plurality of wells or sample tubes. These sensors may include, for example, acoustic sensors, weight sensors, pressure sensors, laser sensors, capacitive sensors, etc. In some embodiments, the waste management system includes one or more scales for determining an amount of fluids removed from the plurality of wells or sample tubes using a vacuum.

### BRIEF DESCRIPTION OF THE DRAWINGS

FIG. 1 shows an embodiment of a modular liquid handling system.

FIG. 2 shows an embodiment of a platform supported on a tip tilt stage.

FIG. 3 shows an embodiment of a modular liquid handling system.

FIG. 4 shows an embodiment of a modular liquid handling system

FIG. 5 shows an embodiment of a liquid level sensor.

FIG. 6 shows an embodiment of a control system for controlling a plurality of modular liquid handling systems.

FIG. 7 shows an embodiment of a liquid dispensing module with an internal liquid reservoir.

FIG. 8 shows an embodiment of a liquid dispensing module with two inlets, a first inlet for reagent and a second for addition of a liquid for flushing salt or other unwanted substances from the dispensing nozzles.

FIG. 9 shows an embodiment of a liquid dispensing module in which a valve is placed on the opposite end of the dispensing manifold from the inlet.

FIG. 10 shows an embodiment of an integrated modular liquid handling system with an optional wash trough (e.g., sonication trough).

FIG. 11 shows an embodiment of a wash trough (e.g., sonication trough).

FIG. 12 is an exploded view of an embodiment of a well sensor, e.g., an ultrasonic well sensor, integrated with a dispensing module.

FIG. 13 shows an embodiment of a well-sensor modular device mounted on a liquid dispensing modular device

FIGS. 14A-14D show an embodiment of “stackable” modular liquid dispensing modules that are configured with nozzles that correspond to rows of 12 wells of a 96 well plate. FIG. 14A shows a module with 12 nozzles, corresponding to one row of a 96 well plate. FIG. 14B shows a second module attached to add a second row of 12 nozzles. FIG. 14C shows a third module attached to add a third row of 12 nozzles. FIG. 14D shows a fourth module attached to add a fourth row of 12 nozzles.

FIG. 15 shows an embodiment of an adaptor for disposable aspirator tips.

FIG. 16 shows an aspirator manifold with adaptors configured for attachment of disposable aspirator tips.

FIG. 17 shows a cross-sectional view of disposable aspirator tips positioned on adaptors.

FIG. 18 shows a cross-section view of an embodiment in which a push plate is included for removal of disposable aspirator tips.

FIG. 19 shows an embodiment in which a sample processing plate and an aspirator tip box are configured side-by-side.

FIG. 20 shows a top view of an embodiment in which a sample processing plate and an aspirator tip box are configured side-by-side.

FIG. 21 shows an embodiment with a movable drip tray.

FIG. 22 shows a side view of a movable drip tray.

FIGS. 23A and 23B show two embodiments of magnet arrays for concentration of magnetic material in liquid and/or mixing of liquid in wells of a multiwell sample processing plate.

FIG. 24 shows an embodiment of a multiwell sample processing plate configured with a magnet array underneath the plate and configured such that the magnets fit and are movable within the interwell spaces of the plate, concentrating magnetic material in the wells of a multiwell sample processing plate.

FIGS. 25A, 25B, and 25C show an embodiment in which a magnet is moved up and gradually moved down alongside a well of a multiwell sample processing plate to concentrate and pull down magnetic material in liquid in the well.

FIG. 26 shows an embodiment in which a magnet is moved up and down alongside a well of a multiwell sample processing plate to disperse magnetic material in liquid in the well, thereby mixing the liquid in the well.

### DETAILED DESCRIPTION

### Integrated Modular System

Described are integrated modular liquid handling systems, and methods of using such systems. These systems can be used for conducting assays, purifying and/or isolating compounds, and/or treating samples, for example, in sample processing plates containing a plurality of wells or in sample tubes in a tube rack. Also described are components of such modular liquid handling systems, including sample transferring modules, liquid dispensing modules, liquid aspiration modules, modules for sensing parameters in liquid, such as liquid level and/or temperature, modules for detection of signals, and modules for magnetic attraction of magnetic material such as beads in wells of a sample processing plate or in sample tubes. The integrated modular liquid handling systems described herein may also perform various functions with respect to liquids, for example, in wells of a plate or in sample tubes, for example, shaking, mixing, incubation, and/or separation of components of samples. The integrated modular liquid handling systems described herein may also, in some embodiments, be fluidly connected to a waste disposal system. In some embodiments, the modular liquid handling systems may include systems or modules for applying labels to plates, tubes, or tube racks, applying seals to plates, tubes, or tube racks, bar code scanning, and/or a vision system. The modular nature of the systems described herein permit customization depending on the operations to be performed, sequence of liquids to be dispensed, mixed, and/or aspirated, number of liquids to be dispensed, etc.

In some embodiments, the modular liquid handling systems can be integrated with other systems, such as data analysis and output systems for research or diagnostic purposes. The modular liquid handling systems described herein can perform multiple steps of an assay or other workflow for sample processing in a very compact integrated device, including multiple functionalities in less space, and in a way that is faster, more cost-efficient, and produces less waste than previously known systems. Furthermore, the modular liquid handling systems have a more flexible workflow, allowing them to be readily optimized to suit the varying needs of a sample processing system operator. The modular nature of the liquid handling, sensing, and detection devices that may be included in the systems described herein allow for customization depending on the nature of samples to be processed or analyzed and the output desired by the user.

In some embodiments, the integrated modular liquid handling system is further designed to minimize solid and liquid waste by utilizing contactless devices for dispensing, aerating, mixing, and/or aspirating liquids. Directly contacting a liquid results in contaminated equipment, which must be properly sterilized or disposed to prevent contamination of the liquid. For example, disposal of a pipette tip each time a liquid is dispensed, aerated, mixed, or aspirated results in significant solid waste. Solid and liquid waste can be expensive or difficult to dispose of because of the presence of biologically active elements. By minimizing contact with a liquid to be processed, for example, in a well of a plate or in a sample tube, through contactless dispensing, aerating, mixing, or aspirating, generation of solid waste and contamination of liquids can be minimized.

Although contact with a liquid to be processed, for example, in a well of a plate or in a sample tube, is minimized in the modular liquid handling systems described herein, in some embodiments, contact with the liquid may still be made. For example, in some embodiments, a sample transferring device may transfer a sample from a sample tube to a well of a sample plate or to another sample tube by withdrawing the sample into a pipette tip or needle and dispensing the sample into the well of the sample plate or into the second sample tube. Additionally, in some embodiments, liquids aspirated, for example, from wells of plates or from sample tubes, may be contaminated. A modular liquid handling system as described herein may therefore include a waste management system capable of treating and, in some embodiments, disposing of or containing the waste.

To maintain precision between assays or other procedures, thereby increasing processing reliability, liquids should be consistently dispensed. To ensure consistent liquid dispensing and improve processing reliability, some embodiments of the modular liquid handling system include a liquid level sensor, e.g., a contactless liquid level sensor. A liquid level sensor can signal to a control system when sufficient liquid has been dispensed to achieve a predetermined volume. In some embodiments, the liquid level sensor detects the liquid level without directly contacting the sample, i.e., contactless detection. In some embodiments, the liquid level sensor may simultaneously signal to the liquid dispensing device when the dispensing device should continue dispensing liquid and/or when the liquid dispensing device should stop dispensing liquid. The liquid level sensor may be integrated into the liquid dispensing module, or the liquid dispensing and liquid level sensor functions may be in separate modules. Non-limiting examples of liquid level sensors include acoustic and/or laser sensors.

In some embodiments, each work step in a process conducted in an integrated modular liquid handling system as described herein may be a distinct step or event in a complete process, and may use one or more modular devices and/or may dispense and optionally aspirate one or more liquids. For example, in some embodiments, a work step may be a sample transferring step, an incubating step, a mixing step, a heating step, a solution dispensing step, a solution aerating step, a solution aspirating step, a sensing step, or a detecting step. In some embodiments, a work step may include two or more simultaneous events, such as simultaneous dispensing and sensing steps, simultaneous mixing and heating steps, or simultaneous incubating and heating steps. In some embodiments, a work step may include multiple linear or simultaneous smaller work steps, for example, a cell lysis step may include a solution dispensing step, a simultaneous mixing and heating step, and a solution aspirating step. Other work steps may include, but are not limited to, a wash step, an imaging step, a weighing step, a drying step, or an enzymatic reaction step.

Any number of liquids, including liquid solutions, may be used in processing or analyzing a sample in a modular liquid handling system as described herein. For example, a liquid that may be dispensed, for example, into wells of a plate or into sample tubes, includes, but is not limited to, a suspension solution, deionized water, non-deionized water, a lysis solution, a wash solution, an elution solution, an assay solution, a reactive reagent, or an organic solvent. In some embodiments, a liquid solution may include salts, buffers (e.g., acetate, citrate, bis-tris, carbonate, CAPS, TAPS, bicine, tris, tricine, TAPSO, HEPES, TES, MOPS, PIPES, cacodylate, SSC, MES, succinic acid, or phosphates), amino acids, acids, bases, surfactants, detergents (e.g., SDS, triton X-100, or Tween-20), chaotropic agents, chelators (e.g., ethylenediaminetetraacetic acid, phosphonates, or citric acid), preservatives, antibiotics, alcohols (e.g., methanol, ethanol, propanol, or isopropanol), reducing compounds, oxidizing compounds, dyes, or biomolecules (e.g., nucleic acids, proteins, enzymes (e.g., RNase or Proteinase K). In some embodiments, the liquid may contain an affinity reagent, ligand, or substance that may bind to or immobilize one or more components or moieties in a sample. In some embodiments, the liquid may contain affinity beads that contain one or more affinity moiety that is capable of binding to a target molecule when present in a sample. For example, the affinity beads may be magnetic and the modular liquid handling system may contain one or more magnets that are capable of magnetically attracting the magnetic beads and separating the beads from other components in a liquid, for example, a liquid that may contain a target molecule to which the affinity moiety binds.

In some embodiments, the frame of the robotic system may include mounting features that allow auxiliary devices or instruments to be mounted, for example, below the platform for supporting a sample processing plate. For example, a waste drainage tray and/or a cleaning trough, e.g., sonication trough, may be mounted, and in some embodiments may be switched in or out of the system, depending on the operation in progress (e.g., waste disposal or cleaning of portions of a modular device that comes in direct contact with samples, such as aspiration tips and/or dispensing nozzles). In various embodiments, a cleaning trough may be configured for use with a sonication or non-sonication protocol.

### Sample Input and Output

An integrated modular liquid handling system is capable of processing a variety of sample inputs, for example, in assays, diagnostic procedures, purification or separation of components of a sample, or other types of sample processing applications. A modular liquid handling system as disclosed herein is able to accept a sample input and produce a sample output. In some embodiments, a sample input may include, but is not limited to, biomolecules, nucleic acids (including DNA or RNA), proteins, peptides, antibodies, antibody fragments, antibody-small molecule conjugates, enzymes, metabolites, structural proteins, tissues, seeds, cells, organelles, membranes, blood, plasma, saliva, urine, semen, oocytes, skin, hair, feces, cheek swabs, pap smear lysate, organic molecules, pharmaceutical compounds, bacteria, viruses, or nanoparticles.

In some embodiments, samples are pre-loaded into wells of a sample processing plate that contains a plurality of wells or into sample tubes, prior to processing in the modular liquid handling system. In other embodiments, samples are loaded into wells of the plate or into sample tubes by transferring from external sample container(s) through a sample transferring module that includes a pipetting mechanism that is fluidly connected to the sample container(s) and is configured to transfer a predetermined volume of liquid sample from the sample container(s) into wells of the plate or into sample tubes. Samples may be transferred from a variety of containers, for example, a plurality of single tubes, and/or from wells of a plate, for example, a 6-well plate, a 12-well plate, a 24-well plate, a 48-well plate, a 96-well plate, a 192-well plate, a 384-well plate, a 1536-well plate, or a multi-well plate capable of holding any number of separated samples. In some embodiments, samples may be transferred from an array of tubes, for example, a rack of tubes containing liquid samples, e.g., a rack of blood tubes. The number of tubes in the array may correspond, for example, to the number and/or arrangement of wells in a plate to which samples will be transferred or to the number and/or arrangement of sample tubes in a tube rack to which samples will be transferred, or the number of tubes may be smaller or greater than the number of wells of a plate to which samples will be transferred or the number of sample tubes to which samples will be transferred. In some embodiments, each sample container, e.g., sample tube, in the array is identified with a unique identifier such as a barcode. In some embodiments, the sample containers, e.g., sample tubes, in the array can be capped or sealed, for example by a rubber stopper.

The output from a modular liquid handling system as described herein may be of a variety of data types, for example, but not limited to, images, spectroscopy measurements (such as calorimetric, fluorescence measurements, light absorbance, nuclear magnetic resonance, infrared, light scattering spectroscopy, etc.), enzymatic measurements (such as dissociation constants, catalytic rates, kₒₙ rates, k_{off} rates, etc.), or may be a target molecule, for example, but not limited to, DNA, RNA, protein, peptide, or organic compound).

In some embodiments, a laser may be used to generate output that includes the shape and/or profile of the meniscus of liquid in the well of a plate or in a sample tube. This could be used, for example, to ascertain whether or how well liquid in the well or tube had been spun down.

In some embodiments, the color of liquid is measured and the output from the modular liquid handling system includes a quantitative and/or qualitative measure of contamination, e.g., amount and/or presence or absence of one or more contaminating substance(s), in the liquid.

### Sample Processing Plates

In some embodiments, the integrated modular liquid handling system can be configured to utilize a variety of sample processing plates, e.g., plates that include a plurality of wells, including, but not limited to, a 6-well plate, a 12-well plate, a 24-well plate, a 48-well plate, a 96-well plate, a 192-well plate, a 384-well plate, a 1536-well plate, or a multi-well plate capable of holding any number of separated samples. In some embodiments, maximum well volume of the sample processing plate may be about 18 microliters, about 250 microliters, about 1.1 milliliters, about 2.2 milliliters, about 5 milliliters, or about 10 milliliters. In some embodiments, a sample processing plate may be configured such that there is open space between the bottoms and at least a portion of the sides of adjacent wells of the plate, i.e., having interwell space that is accessible from the bottom of the plate.

In some embodiments, each sample processing plate is identified with a unique barcode. In some embodiments, wells of the sample processing plate may be pre-loaded with samples for analysis, or with a liquid, such as a lysis fluid, stabilizing fluid, wash fluid, deionized water, or ethanol prior to adding samples for analysis, prior to addition of the plate to the modular liquid handling system.

In some embodiments, each well of the sample processing plate includes affinity beads that can bind to a target molecule within the sample, which may be added to the wells prior to or after addition of samples for analysis. For example, the affinity beads may be coated in antibodies, streptavidin, or cationic or anionic moieties. In some embodiments, the affinity beads are magnetic. In some embodiments, affinity beads are pre-loaded into the sample processing plate prior to transferring of the sample into the sample processing plate. In some embodiments, affinity beads are not pre-loaded into the sample processing plate, but are added via a liquid dispensing module of the liquid handling system.

### Sample Tubes

In some embodiments, the integrated modular liquid handling system can be configured to utilize a variety of sample tubes that are capable of holding any number of separated samples. In some embodiments, the sample tubes are conical. In some embodiments, the sample tubes are Vacutainer® or similar tubes (i.e., sterile glass or plastic tubes, e.g., round bottom tubes, with a closure, such as a rubber stopper, such that the tubes may be evacuated to create a vacuum inside the tube, thereby facilitating the draw of a predetermined amount of liquid, such as a biological sample). In various non-limiting embodiments, the sample tubes may be configured to contain 5 ml, 15 ml, or 50 ml liquid volumes. The sample tubes may fit into a tube rack for use in the modular liquid handling systems described herein. In some embodiments, the tube rack may be configured such that there is open space between the bottoms and sides of adjacent sample tubes, i.e., having space between tubes that is accessible from the bottom of the tube rack.

In some embodiments, each sample tube and/or tube rack is identified with a unique barcode. In some embodiments, sample tubes may be pre-loaded with samples for analysis, or with a liquid, such as a lysis fluid, stabilizing fluid, wash fluid, deionized water, or ethanol prior to adding samples for analysis, prior to addition of the sample tubes to the modular liquid handling system.

In some embodiments, sample tubes include affinity beads that can bind to a target molecule within the sample, which may be added to the tubes prior to or after addition of samples for analysis. For example, the affinity beads may be coated in antibodies, streptavidin, or cationic or anionic moieties. In some embodiments, the affinity beads are magnetic. In some embodiments, affinity beads are pre-loaded into the sample tubes prior to transferring of the sample into the sample tubes. In some embodiments, affinity beads are not pre-loaded into the sample tubes, but are added via a liquid dispensing module of the liquid handling system.

### Platform

An integrated modular liquid handling system as described herein includes a platform for supporting a sample processing plate, for example, a plate that includes a plurality of wells, or a sample tube rack that is configured to hold a plurality of sample tubes. The platform may be mounted on a planar surface gantry, which may be configured to move the plate in “x” and/or “y” directions, or a combination thereof, in a substantially horizontal planar configuration. The planar surface gantry may move the platform relative to one or more modular device(s) that are supported on a track that is configured to move the modular device(s) in a substantially vertical “z” direction relative to the platform. The platform may contain brackets or another type of attachment to hold a sample processing plate or sample tube rack in a stationary configuration on the platform.

The platform may be configured to perform one or more function(s) with regard to a plate supported thereon, such as, but not limited to, shaking, heating, and/or cooling. In some embodiments, the platform includes tip-tilt mechanism. In some embodiments, the platform includes one or more magnet(s) configured to attract a material, for example, a magnetic material, such as magnetic beads, in wells of a sample processing plate as described herein. In some embodiments, the platform includes a plurality of magnets each configured underneath a well of a sample processing plate or a sample tube when the plate or sample tube rack is supported on the platform. In some embodiments, the platform includes a plurality of magnets configured to move between in the interwell space from below a sample processing plate or configured to move between sample tubes from below a sample tube rack when the sample processing plate or sample tube rack is supported on the platform.

### Magnetic Movement of Liquid

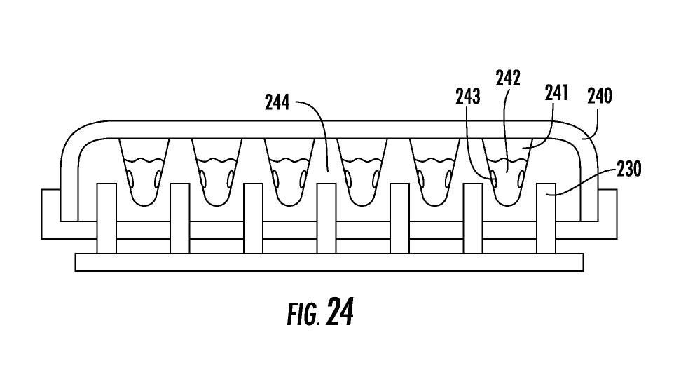

In some embodiments, the sample processing plate or sample tube rack is configured such that there is open space between the bottoms and at least a portion of the sides of adjacent wells of the plate, i.e., interwell spaces that are accessible from the bottom of the plate, or between adjacent sample tubes. In some embodiments, the platform comprises a plurality of magnets, e.g., magnetic pins or rods 230, that are configured to fit into the open spaces 244 between wells of a sample processing plate, as shown schematically in FIG. 24. The platform underneath the sample processing plate 240 is configured such that the magnets 230 may be moved up and down in the interwell spaces, thereby moving magnetic material 243, e.g., magnetic affinity beads, within the liquid 242 in the wells 241. In other embodiments, the platform comprises a plurality of magnets that are configured to fit into the open spaces between sample tubes in a tube rack, and the platform underneath the tube rack is configured such that the magnets may be moved up and down between the sample tubes, moving magnetic material within the liquid in the sample tubes.

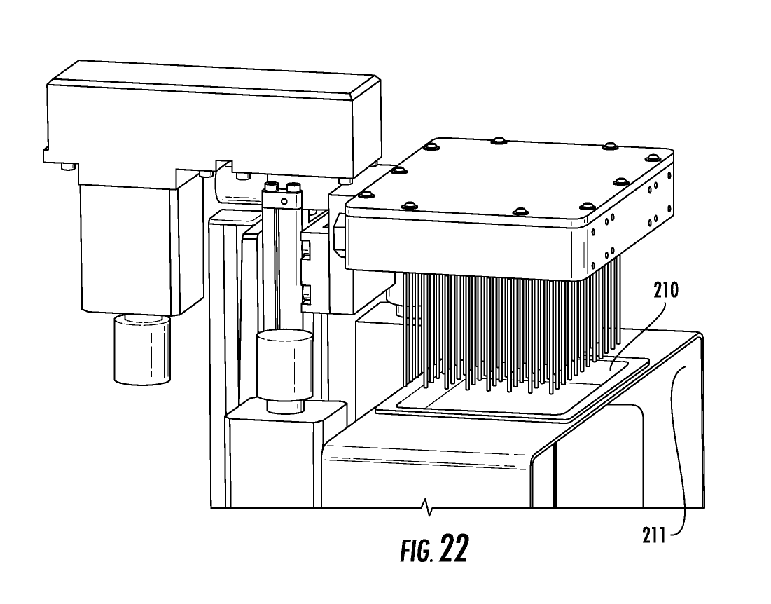

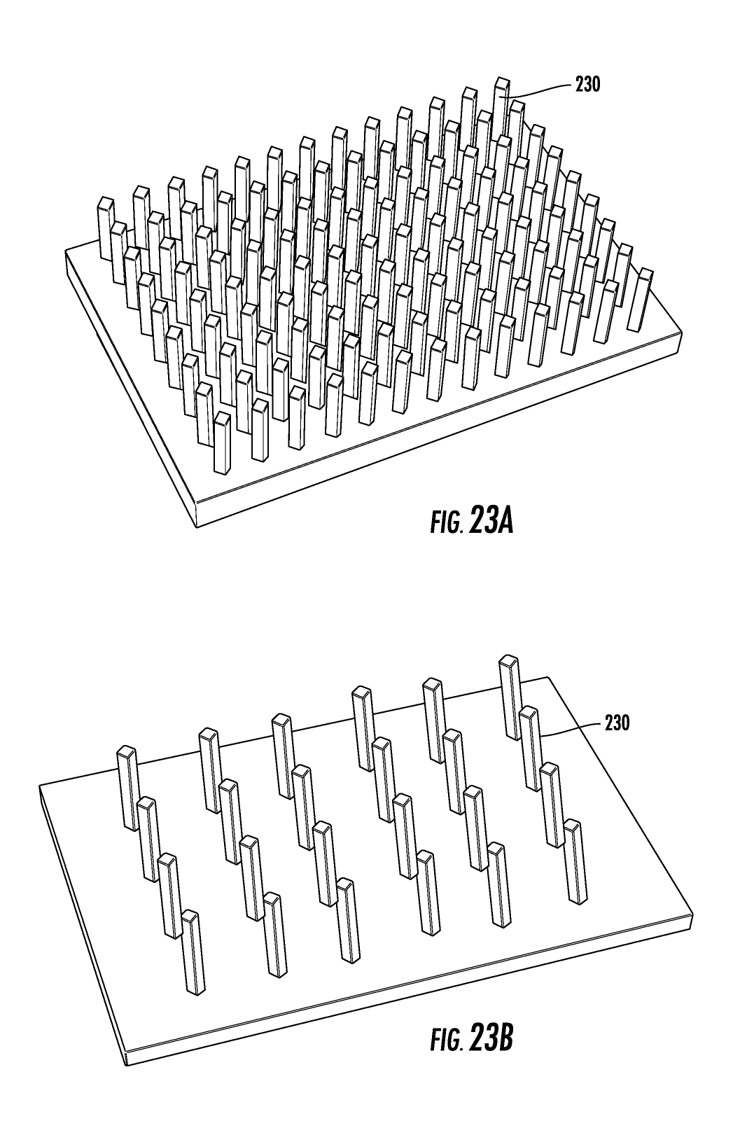

Two nonlimiting examples of magnet arrays are shown in FIGS. 23A and 23B. The magnets may be used to concentrate magnetic material, e.g., beads at a specific location within the wells or sample tubes, facilitating removal of excess fluid and washing of the magnetic material, e.g., magnetic affinity beads. Further, since magnetic field strength is limited by distance, the closer the magnet is to the magnetic material, the better the attraction. The magnetic field may be adjusted inside the well in real time by dynamically moving the magnets in relation to the top and bottom of the well, thereby mixing the magnetic material, e.g., beads, and consequently the liquid within the well or tube. This may be used as an alternative to shaking or inverting the plate or tube rack, which can result in splashing and cross-contamination between wells or tubes, or pipetting liquid up and down, which contacts the liquid, potentially resulting in contamination, and uses consumables (pipet tips). Mixing of the liquid by movement of magnets up and down between wells of the plate or between sample tubes, as described herein, is a contactless mixing method that involves movement of the magnetic material in the wells or tubes rather than the liquid.

In some embodiments, the magnets, e.g., magnetic pins or rods, may be movable relative to the plate or tube rack. In other embodiments, the plate or tube rack may be movable relative to the magnets. In some embodiments, the plate or tube rack is stationary and the magnets are individually movable (e.g., in a vertical (“z”) direction relative to a horizontal configuration of the sample processing plate or tube rack) or magnets covering sections of a plate may be movable together as a group, for example, half plate, quadrants, rows, columns, or other subsections of a plate or tube rack. In one embodiment, the plate or tube rack is configured on a support base that fits beneath the plate rack or tube and contains an array of magnets (e.g., pins or rods) that are configured to move within the interwell spaces of the plate or between sample tubes in the tube. A cushioning material, for example, rubber, may be provided between the outer edges of the sample processing plate or tube rack and the corresponding edges of the support base that the plate or tube rack fits within, to absorb vibration from movement of the magnets. In another embodiment, the magnets are fixedly mounted to a base plate which is configured to be moved relative to the sample processing plate or sample tube rack, to move the magnets between wells of the plate or between sample tubes. In another embodiment, the magnets are fixedly mounted to a base plate and the sample processing plate or sample tube rack is configured to be moved relative to the base plate, to move the magnets between wells of the plate or between sample tubes.

In embodiments in which the magnets are individually movable (i.e., not fixedly mounted to a base plate), magnets may be movable via mechanical devices (e.g., springs) or via actuators (e.g., hydraulic, pneumatic, electrical, thermal, mechanical). In one embodiment, the magnets are movable via an electronically controlled actuator mechanism. In one embodiment, an actuator is coupled to a spring for quick release in one direction.

A magnet array may be configured such that one magnet is used per well or sample tube to move magnetic material within liquid in the well or sample tube, or the array may be configured such that the well or sample tube is surrounded to two or more magnets. For example, a well or sample tube may be surrounded by two magnets that are 180° apart. In one embodiment, a well or sample tube is surrounded by four magnets that are 90° apart.

“Magnets” (e.g, rods or pins that fit within interwell spaces of sample plates or between sample tubes in a tube rack) may be composed entirely of magnetic material, or one or more portion(s), for example, a terminal portion, may be composed of magnetic material. Suitable materials for this purpose include, but are not limited to, Neodymium Iron Boron, Samarium Cobalt, Alnico, Ceramic or Ferrite magnets.

Magnetic material in liquid in the wells of a sample plate may be moved by attraction to the magnets in the interwell spaces of the plates. Such magnetic material may be, for example, in the form of magnetic beads, optionally coupled to affinity ligands, antibodies or fragments thereof, or other reagents for binding or reaction with one or more compounds or components in a liquid sample. Suitable materials for this purpose include, but are not limited to, ferromagnetic materials such as iron, cobalt, nickel, some rare earth metals and various alloys of these materials.

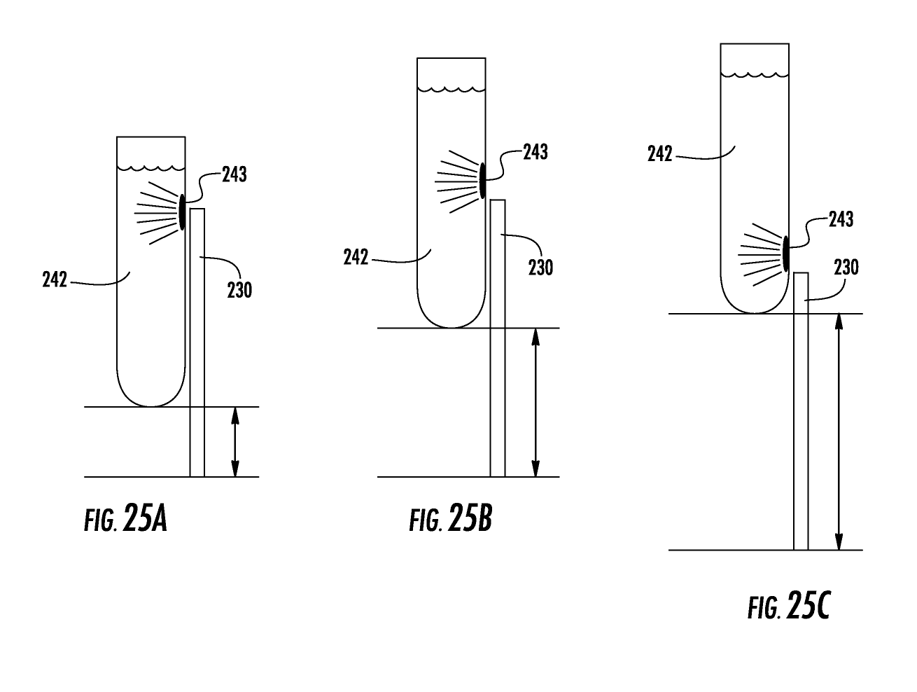

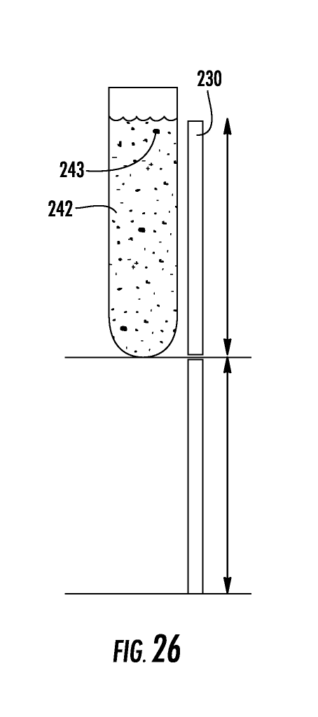

In some embodiments, the magnets are used to concentrate magnetic material at a specific location within the wells or sample tubes 242, shown schematically in FIGS. 25A-25C. For example, the magnets 230 may be moved slowly up and down in the interwell space of a sample processing plate or between sample tubes, and then moved slowly down to concentrate the magnetic material 243, e.g., beads, by attraction to magnet(s) on the outside of the well or sample tube. Movement of the magnets may be controlled by a control system.

In some embodiments, the magnets are used to disperse magnetic material within the wells or sample tube, as shown in FIG. 26. For example, magnets 230 may be moved slowly to the top of the wells or sample tubes and then rapidly moved down to create a dispersion of the magnetic material 243 in the liquid 242. Quick movement may be used to break the magnetic field and disperse the magnetic material 243, e.g., magnetic beads. The rate of movement of the magnet(s) may be adjusted depending on the amount of magnetic material and viscosity of liquid in the well or sample tube, thereby creating a uniform or substantially uniform dispersion of the magnetic material in the well or sample tube and facilitating contactless mixing of the liquid. Movement of the magnets may be controlled by a control system.

### Pumping System

An integrated modular system for liquid handling as described herein includes a pumping system for moving liquids into and out of a sample processing container, for example, wells of a sample processing plate or sample tubes as described herein. The pumping system is external to the liquid handling modules of the system and may be separated by some distance. The pumping system fluidly connects external liquid reservoir(s) with liquid dispensing module(s) and/or fluidly connects aspiration module(s) and/or liquid dispensing module(s) of the system with a waste disposal and/or processing system. In some embodiments, the pumping system contains one or more diaphragm pump(s). In some embodiments, peristaltic pump(s), centrifugal pump(s), syringe pump(s), and/or microannular pump(s) may be employed. In some embodiments, the pumping system includes one or more valve-gated dispensing system backed from a pressurized reservoir.

In some embodiments, a pump can draw liquid from one or more external sample container(s) and/or from one or more external liquid reservoir(s), to dispense a determined or predetermined amount of liquid, for example, into wells of a sample processing plate or sample tubes via fluidly connected nozzles. In some embodiments, two or more pumps draw liquid from two or more different external liquid reservoirs and dispense liquid via the nozzles only after the liquid is mixed by a liquid mixer. In some embodiments, the proportion of mixed liquids is controlled by the rate at which liquid is drawn by the separate pumps. In some embodiments, valves can be included in the system to allow a pump to draw and dispense liquids from multiple external liquid reservoirs.

When the modular liquid handling system is used to dispense a slurry containing magnetic beads, a magnetic bead recirculation pump can be used to keep the beads suspended in the slurry prior to dispensing as the beads can settle out if they are not continuously stirred. The magnetic bead recirculation pump preferably does not include any metal contacts that would attract the magnetic beads. In some embodiments, a continuous recirculating pump with a diaphragm pump with all plastic wetted ports is used.

### Control System

An integrated modular system for liquid handling as described herein includes a control system. The control system is external to the liquid handling modules, and may be separated by some distance. The control system may control one or more function(s) of the liquid handling system, including but not limited to, dispensing of liquid, aspiration of liquid, sensing of a parameter of liquid, such as but not limited to, liquid level and/or temperature, detection of a signal, movement of a platform relative to one or more modular device(s), transfer of sample(s), and/or magnetic attraction of magnetic material such as magnetic beads to effect mixing with liquid, heating, cooling, and/or shaking of a sample processing plate. In some embodiments, a plurality of liquids may be dispensed and/or aspirated, for example, dispensed into and/or aspirated out of wells of a sample processing plate or sample tubes, and the control system may control the sequence of such dispensing and/or aspiration of liquid. In some embodiments, one or more liquid(s) may be dispensed and/or aspirated, for example, dispensed into and/or aspirated out of wells of a sample processing plate or sample tubes, and a signal may be detected after such dispensing and/or aspiration, and the control system may control the sequence of such dispensing and/or aspiration of liquid and subsequent detection of a signal.

In some embodiments, a control system may be configured to control a plurality of modular liquid handling systems as described herein. In one embodiment, a control system is connected to a first modular liquid handling system, and the first modular liquid handling system is connected to a second modular liquid handling system, and additional modular liquid handling systems, if any, may be connected in series. The connection between modular liquid handling systems may be, for example, via cables or wireless transmission. In other embodiments, a control system is connected to two or more modular liquid handling systems in parallel, for example, via cables or wireless transmission.

### Dispensing of Liquids

An integrated modular system for liquid handling as described herein includes one or more liquid dispensing module(s). In some embodiments, a liquid dispensing module is fluidly connected to an external liquid reservoir and the dispensing module is configured to dispense liquid from the external reservoir. External liquid reservoir(s) may be separated by some distance from liquid handling module(s). In some embodiments, the dispensing module is configured to dispense a predetermined volume of liquid from the external liquid reservoir into wells of a sample processing plate or into sample tubes. In some embodiments, dispensing of liquid is contactless.

In some embodiments, the liquid dispensing module contains a plurality of dispensing nozzles. In some embodiments, the dispensing module may contain a number and configuration of nozzles corresponding to the number and configuration of wells in a sample processing plate or sample tubes. In some embodiments, the dispensing module may contain a number and configuration of nozzles corresponding to the number and configuration of a row or column of wells in a sample processing plate or sample tubes in a tube rack. In some embodiments, the dispensing nozzles comprise, consist of, or consist essentially of plastic, such as, but not limited to PEEK, polycarbonate, polypropylene, Teflon®, and/or other biocompatible plastic.

In some embodiments, the liquid dispensing module is configured to dispense liquid from a first external liquid reservoir and is configured to flush the dispensing nozzles with water or a solvent from a second external reservoir to remove salt and/or other unwanted substances in liquid in the first liquid reservoir that could foul or clog the nozzles if not removed. In some embodiments, liquid from the second external reservoir that is flushed through the nozzles is conducted to a waste disposal system.

In some embodiments, the modular liquid handling system includes a plurality of liquid dispensing modules and a plurality of external liquid reservoirs that contain different liquids. Each external liquid reservoir may be fluidly connected to a different liquid dispensing module.

In some embodiments, liquid dispensing modules include an internal liquid reservoir, and liquid from the external liquid reservoir is conducted to the internal liquid reservoir of the liquid dispensing module and is then dispensed through dispensing nozzles.

In some embodiments, a liquid dispensing module is a contactless liquid dispensing device that can dispense a predetermined amount of liquid, for example, into a plurality of wells of a sample processing plate or into sample tubes. A contactless fluid dispensing device can dispense liquid without contacting liquid already present, for example, in the wells of a sample processing plate or in sample tubes.

The amount of liquid dispensed is controlled by the control system, and may be predetermined or determined by the control system in response to an earlier or simultaneous liquid level determination. The liquid dispensing device can dispense liquids based, for example, on an assay and/or extraction method to be deployed.

In some embodiments, a sample processing plate or sample tube rack can be moved to allow the wells of the plate or the sample tubes to be disposed directly underneath the liquid dispensing nozzles, by use of the planar surface gantry that supports the platform on which the plate is disposed. In other embodiments, the fluid dispensing nozzles can be moved to allow the fluid dispensing nozzles to be disposed directly above the wells of the sample processing plate or the sample tubes. In some embodiments, a plurality of wells (e.g., all of the wells or a portion such as a row or column of wells) of a sample processing plate or a plurality of sample tubes (e.g., all of the sample tubes or a portion such as a row or column of tubes in the tube rack) receive liquid simultaneously, while in some embodiments, the wells of the sample processing plate or the sample tubes receive liquid sequentially.

In some embodiments, the liquid dispensing system includes a drainage tray disposed underneath a sample processing plate or tube rack while liquid is being dispensed, which allows collection of any liquid which might accidently overflow from the sample wells or tubes. In some embodiments, the drainage tray is fluidly connected to a waste management system. Overflowed samples as well as waste from priming and purging of the dispensing lines, which may include biohazardous waste, can then be safely disposed by the waste management system without the need for substantial cleanup of the liquid dispensing system.

In some embodiments, the liquid dispensing module(s) may be configured to dispense one or more different types of liquid. In some embodiments, the modular liquid handling system may include one or more liquid valve(s). Valve(s) may be configured to allow liquid to be pulled from one or more external liquid reservoir(s). The external liquid reservoirs may include a variety of liquids, for example, washes, reagents, rinses etc. The liquids may be pre-mixed before being dispensed. The external liquid reservoirs may be scalable according to the volume used in the system and the volume of the source liquid. The scalability of these reservoirs helps allow for unattended operation of the system during operation.

The liquid dispensed to a well of a sample processing plate may be about 0.1 μl (100 nl) to about 5000 μl (5 ml). In some embodiments, the dispensed liquid is about 0.1 microliter to about 0.25 microliter, about 0.25 microliter to about 0.5 microliter, about 0.5 microliter to about 1 microliter, about 1 microliter to about 5 microliters, about 5 microliters to about 10 microliters, about 10 microliters to about 25 microliters, about 25 microliters to about 50 microliters, about 50 microliters to about 100 microliters, about 100 microliters to about 150 microliters, about 150 microliters to about 250 microliters, about 250 microliters to about 500 microliters, about 500 microliters to about 1000 microliters, about 1000 microliters to about 2000 microliters, about 2000 microliters to about 3000 microliters, about 3000 microliters to about 4000 microliters, or about 4000 microliters to about 5000 microliters. In some embodiments, the dispensed liquid is larger than about 5000 microliters.

The liquid dispensed to a sample tube may be about 5 ml to about 50 ml. In some embodiments, the dispensed liquid is about 5 ml to about 10 ml, about 10 ml to about 15 ml, about 15 ml to about 20 ml, about 20 ml to about 25 ml, about 25 ml to about 30 ml, about 30 ml to about 35 ml, about 35 ml to about 40 ml, about 40 ml to about 45 ml, or about 45 ml to about 50 ml. In some embodiments, the dispensed liquid is less than about 5 ml or greater than about 50 ml.

### Aspiration of Liquids

In some embodiments of a modular liquid handling system as described herein, an aspiration module may be deployed to aspirate liquids from wells of the sample processing plate or from sample tubes. In some embodiments, liquid is aspirated from a plurality of wells (e.g., all of the wells or a portion such as a row or column of wells) of a sample processing plate simultaneously, while in some embodiments, liquid is aspirated from wells of the sample processing plate sequentially. In some embodiments, liquid is aspirated from a plurality of sample tubes (e.g., all of the tubes or a portion such as a row or column of tubes) of a tube rack simultaneously, while in some embodiments, liquid is aspirated from sample tubes in the tube rack sequentially. In some embodiments, the aspiration module conducts contactless aspiration of liquids from the wells or sample tubes. The liquid aspirator may include one or more aspirating nozzles and a waste conduit fluidly connected to a waste management system. In some embodiments, the liquid aspiration module may also include a liquid level sensor, e.g., a contactless liquid level sensor configured to allow the determination of the liquid level in the sample wells of the sample processing plate or in the sample tubes before, during, or after the liquid aspiration, e.g., contactless liquid aspiration, step.

In some embodiments, a suction force allows one or more liquid aspirating nozzles to draw fluid contained within one or a plurality of wells of a sample processing plate or one or a plurality of sample tubes. In some embodiments, a vacuum, blower, or waste management system may provide the suction force. In some embodiments, the suction force is less than about −10 mm Hg relative to ambient, less than about −15 mm Hg relative to ambient, less than about −20 mm Hg relative to ambient, or less than about −30 mm Hg relative to ambient pressure. In some embodiments the liquid travels through a waste management conduit to a waste management system, where it can be treated and disposed of. In some embodiments, the suction force is strong enough to pull liquid from the meniscus of the sample without making contact with any retained sample. In some embodiments, the fluid aspirating nozzles are lowered into the sample wells or tubes by a device to maintain an approximately equal distance from the tip of the fluid aspirating nozzles and the meniscus of the plurality of samples.

In some embodiments, such as when magnetic affinity beads are used to bind target molecules, the sample processing plate or sample tube rack may sit upon a magnetic base. The magnetic base forces the magnetic affinity beads to the bottom of the sample wells or tubes, thereby avoiding the suction force of the liquid aspiration nozzles. This may substantially prevent sample loss during the liquid aspiration step, as it decreases the likelihood affinity beads will be unintentionally aspirated from the sample wells or tubes. In some embodiments, a sample processing plate is configured such that there is space between the bottoms and at least a portion of sides of the wells, and the plate is configured above a platform with magnets that fit into the open areas between the wells. The magnets may be used to concentrate and immobilize magnetic affinity beads prior to aspiration of the liquid from the wells. In some embodiments, a sample tube rack is configured such that there is space between sample tubes and the rack is configured above a platform with magnets that fit into the open areas between the sample tubes. The magnets may be used to concentrate and immobilize magnetic affinity beads prior to aspiration of the liquid from the tubes.

In some embodiments, the liquid aspiration module includes a plurality of aspirating nozzles. In some embodiments, the liquid aspirator includes as many aspirating nozzles as there are sample wells in the sample processing plate or sample tubes in a tube rack. In some embodiments, the liquid aspirator includes fewer aspirating nozzles than the number of sample wells in the sample processing plate or sample tubes in the tube rack. In some embodiments, the liquid aspirator includes as many aspirating nozzles as there are wells in a single column or single row of the sample processing plate or sample tubes in the tube rack. In some embodiments, the aspirating nozzles are fluidly connected to a nozzle array.

In some embodiments, an aspirating waste conduit fluidly links the aspiration nozzles, e.g., nozzle array, with a vacuum source, for example for conducting liquid waste that is removed through the aspiration nozzles to a waste management system. In some embodiments, the vacuum source provides a pressure gradient, allowing liquid to flow through the aspirating nozzles, e.g., nozzle array, and aspirating waste conduit. In some embodiments, the vacuum source provides a sufficiently strong vacuum such that the aspirating nozzles can siphon fluid from a sample well in the sample processing plate without traversing the sample meniscus.

In some embodiments, the aspirating nozzles are configured to maintain a distance from the sample meniscus such that liquid is continuously aspirated from the sample until a predetermined amount of fluid is aspirated. In some embodiments, the aspirating nozzles are lowered into the sample wells of the sample processing plate or into the sample tubes to maintain an appropriate distance from the sample meniscus as liquid is being aspirated.

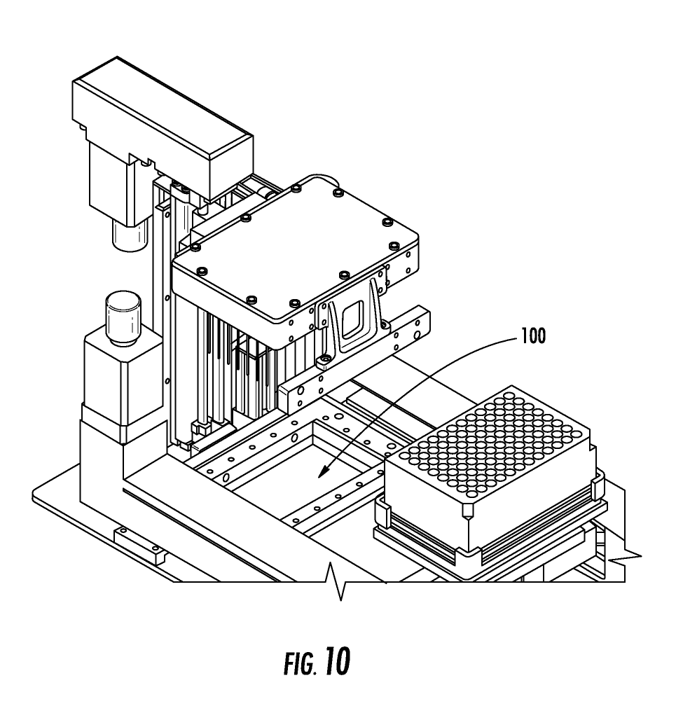

In some embodiments, the aspiration manifold and/or aspiration nozzles are cleaned via sonication. Optionally, a sonication trough may be mounted on the robotic system, below the aspiration nozzles, one embodiments of which is depicted in FIG. 10. Reagents, such as but not limited to, detergents, may be filled and pumped out of the sonication trough to facilitate the cleaning process.

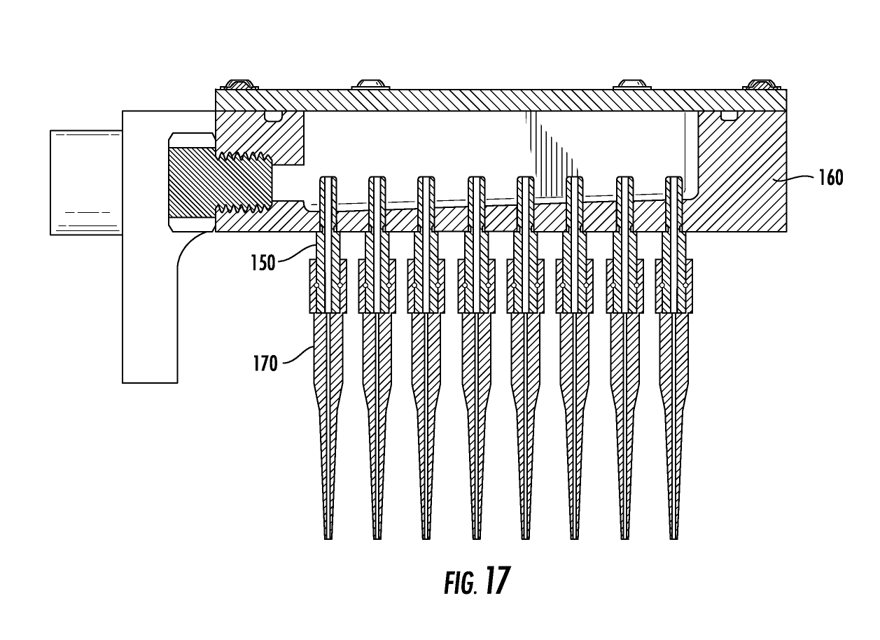

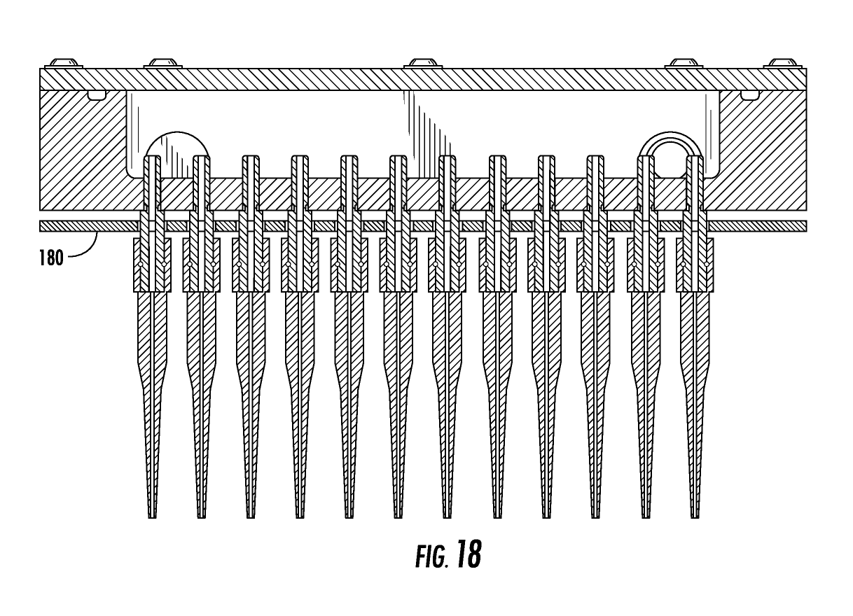

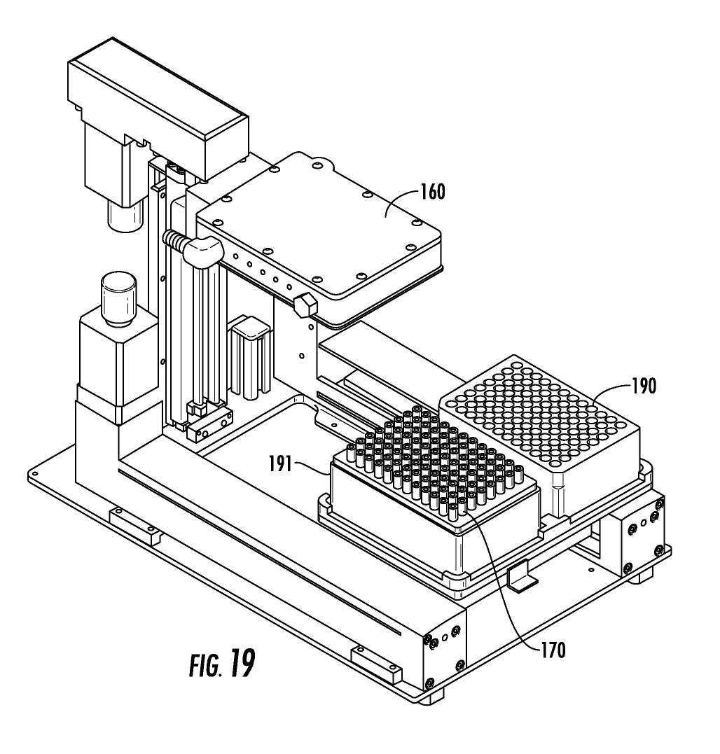

In some embodiments, disposable aspirator tips are used. Disposable tips may eliminate the need for cleaning between aspiration operations. This may be particularly advantageous in applications in which contamination may be an issue, such as nucleic acid amplification. Adaptors for disposable aspirator tips may be provided on the aspirator manifold. One example of an adaptor 150 is shown in FIG. 15, and an example of an aspirator manifold 160 configured with adaptors for disposable tips is shown in FIG. 16. FIG. 17 shows a cross-sectional view of disposable aspirator tips 170 positioned on adaptors 150 for fluid transport of liquid from wells of a sample processing plate, for example, to a waste management system. FIG. 18 shows an embodiment in which a push plate 180 is included for removal of the disposable aspirator tips from the adaptors. In some embodiments, the tips may be loaded onto the adaptors by application of a vacuum and may be ejected from the adaptors with the push plate.

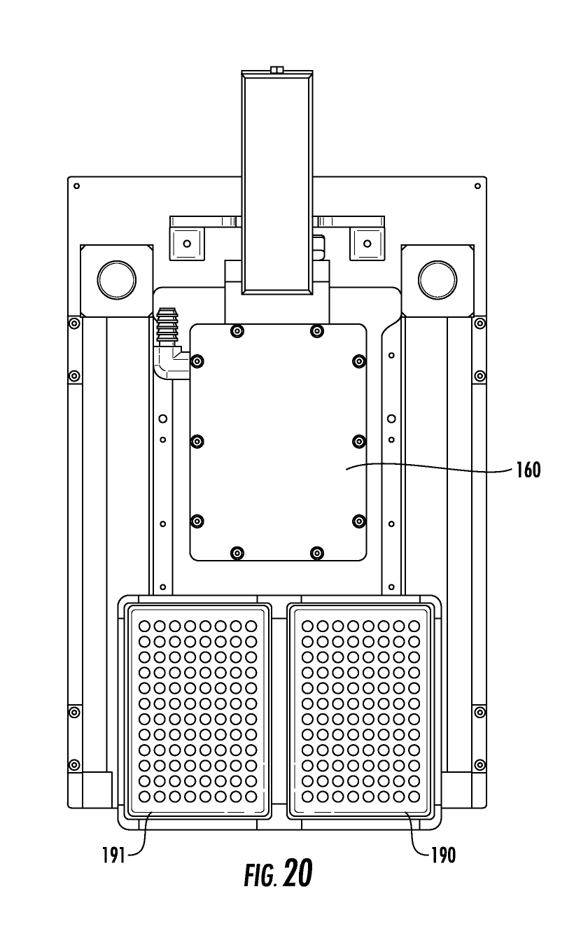

In some embodiments, a sample processing plate 190 and aspirator tip box 191 may be positioned side-by-side, shown schematically in FIG. 19. The tips 170 may be loaded onto adaptors on the aspiration manifold 160, and after aspiration from wells of the sample processing plate, the tips may be returned to the tip box, using the robotic system of the integrated modular liquid system. A top view of an embodiment of such a system is shown in schematically in FIG. 20.

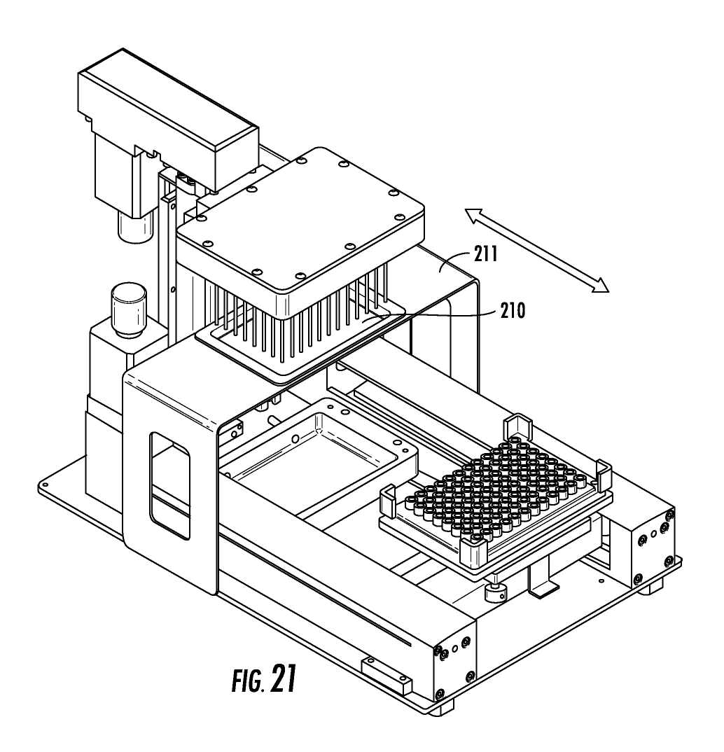

In some embodiments, a drip tray is included to prevent contamination of samples with residual liquid on aspirator tips, and/or other modular devices (e.g., drips from dispense nozzles). One embodiment of a drip tray 210 is shown in FIG. 21. In the embodiment depicted in FIG. 21, drip tray 210 is configured on a support 211 such that it may travel in the “y” direction. In some embodiments, the drip tray may travel in the “y” direction above the sample processing plate, thus providing protection from contamination from above the sample wells, for example, protecting from drips as the plate moves under the aspirator. A drip tray may be included in conjunction with disposable or non-disposable aspirator tips. A side view of the drip tray 210 and support 211 are shown in FIG. 22.

### Sensors

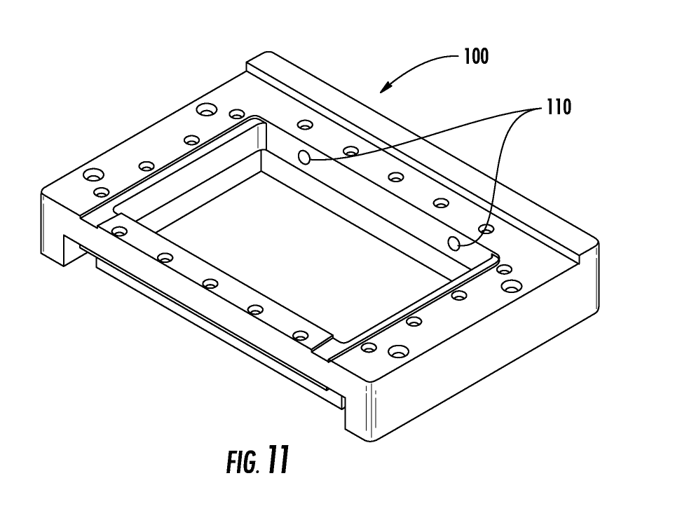

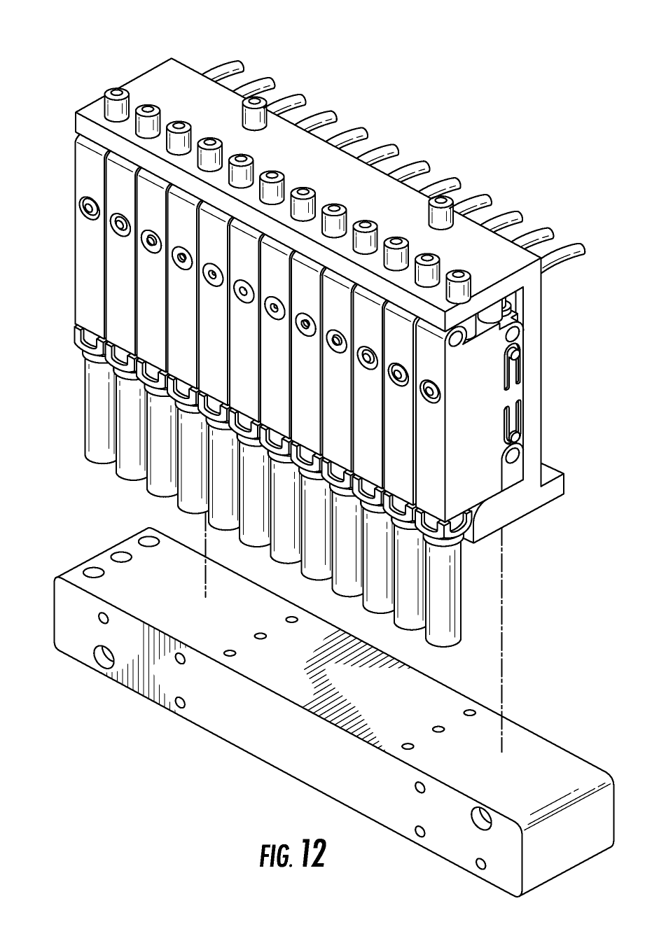

In some embodiments, a modular liquid handling system as described herein contains one or more sensor(s) for sensing one or more parameter(s) relating to liquid, for example, liquid in wells of a sample processing plate or in sample tubes as described herein. The sensor(s) may sense a parameter such as, but not limited to, liquid level and/or liquid temperature. Sensor(s) may be built into a liquid dispensing and/or a liquid aspiration module, or may be in module(s) that are separate from the liquid dispensing and/or aspiration module(s). One embodiment in which a well sensor, e.g., an ultrasonic well sensor, is integrated with and mounted on a liquid dispensing module is shown schematically in FIGS. 12 and 13. In one embodiment, a sensor may be in a module that is adjacent to a liquid dispensing and/or aspiration module, and the system may be configured for sensing, dispensing or aspirating, and then sensing again.

In some embodiments, a liquid level sensor, for example, a contactless liquid level sensor system, including one or more liquid level sensors, e.g., contactless liquid level sensors, can be used to determine the amount of liquid in a well of a sample processing plate or in a sample tube. In some embodiments, an array of contactless liquid level sensors may be used to simultaneously determine the liquid level of a plurality of wells in a sample processing plate or of a plurality of sample tubes in a tube rack.

In some embodiments, the liquid level is measured as volume of liquid within the well or sample tube, approximate meniscus distance from the sensor, approximate meniscus distance from the top of the well or sample tube, or approximate meniscus distance from the bottom of the well or sample tube. In some embodiments, knowledge of the liquid level within a well or sample tube is important for system monitoring, to ensure the liquid dispensing module is dispensing the desired liquid volume and/or the aspirating module is aspirating the desired liquid volume. This can help minimize well or tube overflow and ensure consistency.

The liquid level can be determined in a variety of ways, for example, using weight, digital imaging, ultrasonic, or a laser level transmitter. In some embodiments, the liquid levels are measured using sonar or acoustic waves, for example ultrasonic sound waves. In one embodiment, a liquid level sensor includes a speaker, configured to transmit ultrasonic waves, and a microphone, configured to receive ultrasonic waves. The ultrasonic waves transmitted by the speaker can reflect off a sample meniscus and be received by the microphone. In some embodiments, the signals are transmitted to an amplifier. The liquid level in the sample well can be determined by the difference between the transmission and receiving time of the ultrasonic waves.

In some embodiments, the liquid level sensor has a diameter of about the same size as the diameter of the sample wells or tubes. In some embodiments, the sensor has a diameter of about 20 mm or less, about 15 mm or less, about 9 mm or less, about 7 mm or less, or about 5 mm or less, or about 2 mm or less. In some embodiments, the speaker transmits sound waves of about 20 kHz or more, about 50 kHz or more, about 150 kHz or more, about 350 kHz or more, or about 500 kHz or more. In some embodiments, the sensor has a resolution of about 50 micrometers or less, about 30 micrometers or less, about 20 micrometers or less, about 10 micrometers or less, or about 5 micrometers or less. In some embodiments, the sensor can accurately measure the distance of a meniscus less than about 5 mm away or closer, about 10 mm away or closer, about 25 mm away or closer, about 50 mm away or closer, about 100 mm away or closer, about 150 mm away or closer, or about 250 mm away or closer. In some embodiments, the liquid level can be determined in less than about 30 seconds per reading, less than about 15 seconds per reading, less than about 10 seconds per reading, less than about 5 seconds per reading, less than about 2 seconds per reading, or less than about 1 second per reading.

In some embodiments, a temperature sensor, for example, a contactless temperature sensor system, including one or more temperature sensors, e.g., contactless temperature sensors, can be used to determine the temperature of liquid in a well of a sample processing plate or in a sample tube. In some embodiments, an array of contactless temperature sensors may be used to simultaneously determine the temperatures of a plurality of wells in a sample processing plate or a plurality of sample tubes in a tube rack.

### Signal Detection

In some embodiments, a modular liquid handling system as described herein contains one or more system(s) for detection of one or more signal(s). In some embodiments, a signal, including, but not limited to, a light absorbance signal, a fluorescence signal, or a luminescence signal, may be detected. In some embodiments, the signal is detected in in wells of a signal processing plate or in sample tubes. In some embodiments, aliquots of liquid may be moved from wells of a signal processing plate or from sample tubes to another signal processing plate prior to detection of the signal(s).

For example, in an assay or diagnostic method, one or more liquid(s) may be added to samples, for example, in wells of a sample processing plate or in sample tubes, wherein the liquid(s) contain one or more substance(s) or molecule(s) that produce a signal when in contact with a target molecule or substance if present in the sample. For example, liquids dispensed through a liquid dispensing module of the modular liquid handling system may contain one or more affinity reagent(s) that bind to target molecule(s) when present in a sample. Affinity reagent(s) may include, but are not limited to, antibodies, peptides, nucleic acids, or other small molecules that specifically bind to a target molecule or substance. An affinity reagent may produce a detectable signal when bound to a target molecule or substance, or a secondary reagent may be added that produces a signal when bound to or when interacting with the affinity reagent that is bound to the target or that produces a signal when bound to or interacting with the target when separated from other components of a sample. For example, one or more affinity reagent(s) may be attached to beads, such as magnetic beads, that may be separated from other components of the sample. In some embodiments, a further liquid reagent may be dispensed that contains a molecule or substance that produces a signal when in contact with a target molecule if bound to the affinity reagent(s).

Nonlimiting examples of reagents that may be used for signal detection include ROX (carboxy-X-rhodamine) for volume measurement, and pico green or broad range dyes for DNA quantification.

### Vision System

In some embodiments, a modular liquid handling system as described herein contains one or more vision system(s), e.g., camera and computer. In one embodiment, the vision system can read and decode 1-dimensional and/or 2-dimensional barcodes on the sides of tubes, on the bottom of tubes, on the sides of plates, and/or on the bottom of plates. Different actions may be performed by the liquid handling system based on the barcodes present.

### Transfer of Samples

In some embodiments, an integrated modular liquid handling system as described herein includes a sample transferring module that can transfer a plurality of liquid samples from a plurality of sample containers to a plurality of wells of a sample processing plate or to a plurality of sample tubes in a tube rack. The transferred samples can then continue to be processed, for example, by one or more operations of other modules of the system, including, but not limited to, dispensing of liquid(s), aspiration of liquid(s), sensing of one or more parameters of liquid in the wells of the plate, and/or detection of a signal in wells of the plate. In some embodiments, the sample transferring module includes a pipetting mechanism for transferring of samples from sample containers to wells of the plate, for example, one or more syringe based pipettes (and/or other liquid transferring devices peristaltic pump, centrifugal pumps, microannuler pumps, etc.). In some embodiments, the sample containers are barcoaded or otherwise uniquely identified and the sample identification information is integrated into the output from the liquid handling system. In some embodiments, the pumping system of modular liquid handling system is configured to transfer a predetermined amount of liquid samples through the pipetting mechanism into wells of the sample processing plate or into sample tubes.

A predetermined amount of sample may be drawn from a sample container into a pipette. In some embodiments, a plurality of samples is simultaneously drawn into a plurality of pipettes. In some embodiments, the samples are mixed prior to drawing a sample into the pipette. For example, blood samples may need to be mixed because of settling. The samples may be mixed using the pipettes, for example by repeatedly drawing and ejecting a portion of the sample using the pipettes. In some embodiments, the sample containers are mixed using an orbital shaker or other contactless mixing device.

The drawn sample that is transferred to a well of a sample processing plate may be about 0.1 μl (100 nl) to about 5000 μl (5 ml). In some embodiments, the drawn sample is about 0.1 microliter to about 0.25 microliter, about 0.25 microliter to about 0.5 microliter, about 0.5 microliter to about 1 microliter, about 1 microliter to about 5 microliters, about 5 microliters to about 10 microliters, about 10 microliters to about 25 microliters, about 25 microliters to about 50 microliters, about 50 microliters to about 100 microliters, about 100 microliters to about 150 microliters, about 150 microliters to about 250 microliters, about 250 microliters to about 500 microliters, about 500 microliters to about 1000 microliters, about 1000 microliters to about 2000 microliters, about 2000 microliters to about 3000 microliters, about 3000 microliters to about 4000 microliters, or about 4000 microliters to about 5000 microliters. In some embodiments, the drawn sample is larger than about 5000 microliters.

After transferring of samples into wells of the sample processing plate or into sample tubes, the pipettes may be flushed by, for example, drawing deionized water or other washing solution into the pipettes and then dispensing the wash solution into a waste receptacle, which may be fluidly coupled to a waste management system by a waste conduit where the waste may be treated and disposed of.

### EXEMPLARY EMBODIMENTS

The following exemplary embodiments are intended to illustrate, but not limit, the invention.

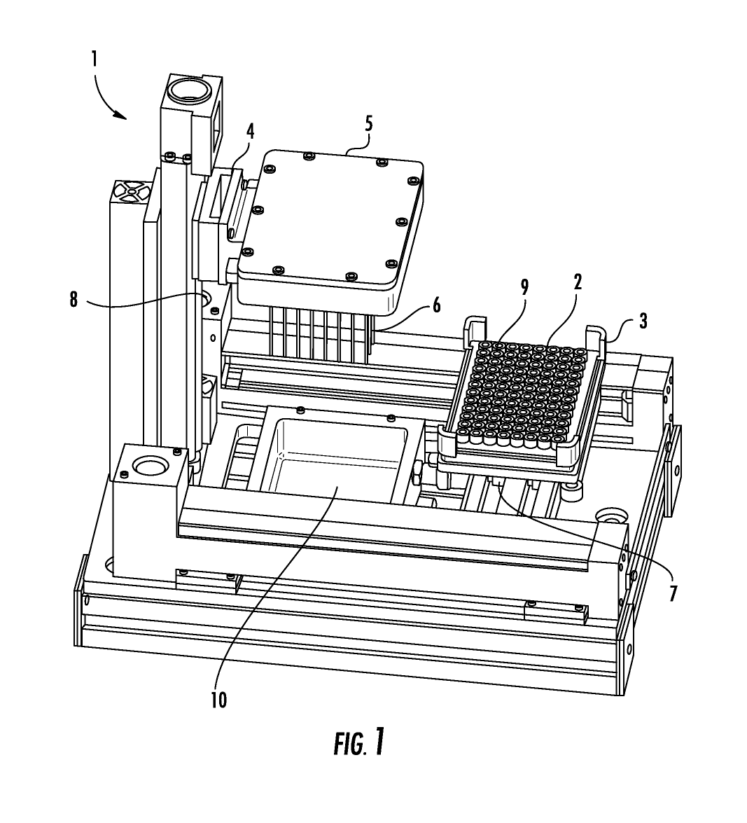

FIG. 1 shows an embodiment of an integrated modular liquid handling system 1 as described herein. The liquid handling system includes a platform 2, configured to support a sample processing plate with brackets 3 at the corners of the platform, and a support 4 for attaching at least one modular device 5 as described herein. The modular device depicted in FIG. 1 contains aspirating tips 6 for aspirating liquid out of wells of a plate. The platform is mounted on a planar surface gantry 7 that is configured to slide in a substantially horizontal x and/or y direction. The support 4 is mounted on a track 8 for sliding the modular device(s) in a substantially vertical z direction. Optionally, the platform includes magnets 9 for magnetically attracting magnetic materials such as beads in wells of the sample processing plate. Optional waste trough 10 is also depicted.

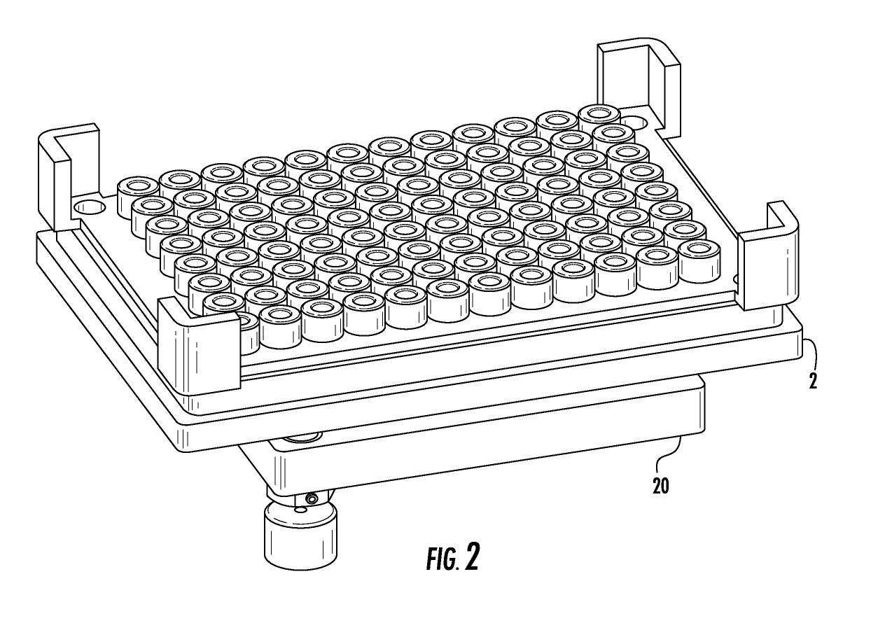

FIG. 2 shows an embodiment of platform 2 supported on a tip tilt stage 20.

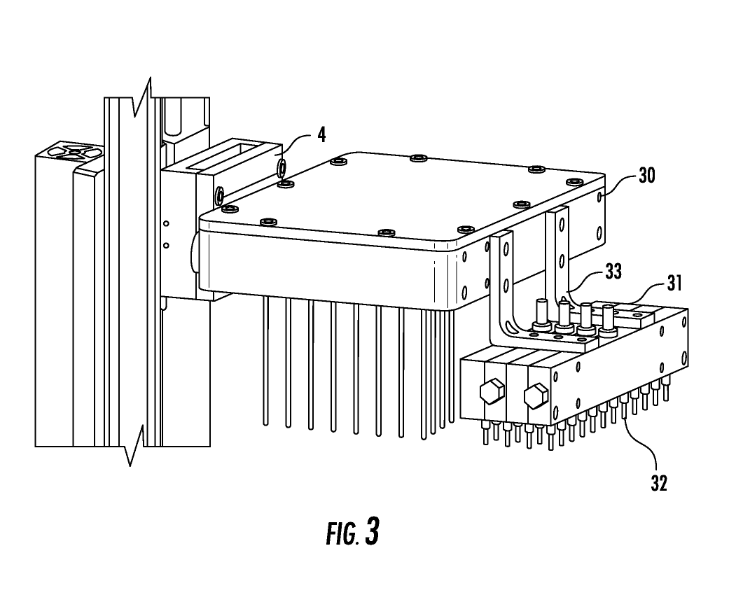

FIGS. 3 and 4 show an embodiment of an integrated modular liquid handling system with modular devices configured in series. As shown in FIG. 3, an aspirator module 30 is attached to support 4, and liquid dispensing modules 31 with compact dispensing tips 32 are attached to the aspirator module, optionally with offset brackets 33. A related embodiment with dispensing tip extenders 40 is shown in FIG. 4. In some embodiments, the dispensing tip extenders may reduce or eliminate the need for offset brackets 33 and may result in better fluidic performance.

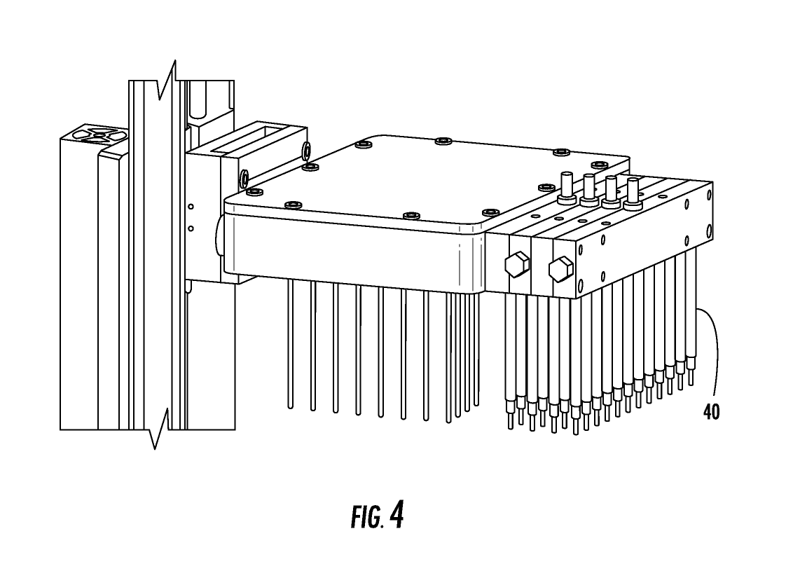

FIG. 5 depicts one embodiment of a contactless liquid level sensor. A sensor 50 includes a speaker 51, configured to transmit ultrasonic waves, and a microphone 52, configured to receive ultrasonic waves. The ultrasonic waves transmitted by the speaker 51 can reflect off a sample meniscus 53 and be received by the microphone 52. In some embodiments, the signals are transmitted to an amplifier. The liquid level of the sample well can be determined by the difference between the transmission and receiving time of the ultrasonic waves.

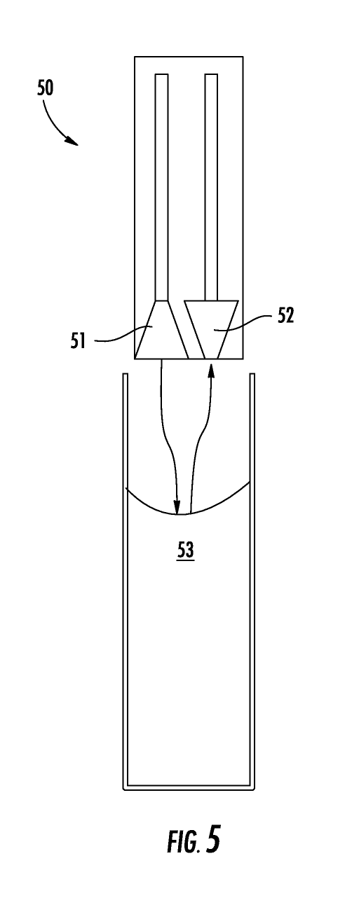

One embodiment of a control system for controlling multiple functions in multiple modular liquid handling systems is shown in FIG. 6. A programmable logic controller (PLC) 60 may be connected (e.g., via cables, wirelessly, or via a remote system such as via the Internet) to a control unit 61, which controls liquid pumping 63 and other functions for a first modular liquid handling system 62. Control unit 61 may be connected in turn (e.g., via cables, wirelessly, or via a remote system such as via the Internet) to control unit 64, which controls liquid pumping 66 and other functions for a second modular liquid handling system 65. Additional modular liquid handling systems may be connected in series in a similar manner. Control units 61 and 64, and pumping functions 63 and 66 are powered via local power sources 67 and 68. In the embodiment depicted in FIG. 6, Beckhoff is a PLC (a real time computer), the “slices” are boards that permit connection of devices such as, but not limited to, sensors, motors, and switches to the computer for control of these devices by the computer. In this embodiment, single controller (computer) can control multiple modular liquid handling systems and the modular devices included therein rather than one control system (computer) per liquid handling system.

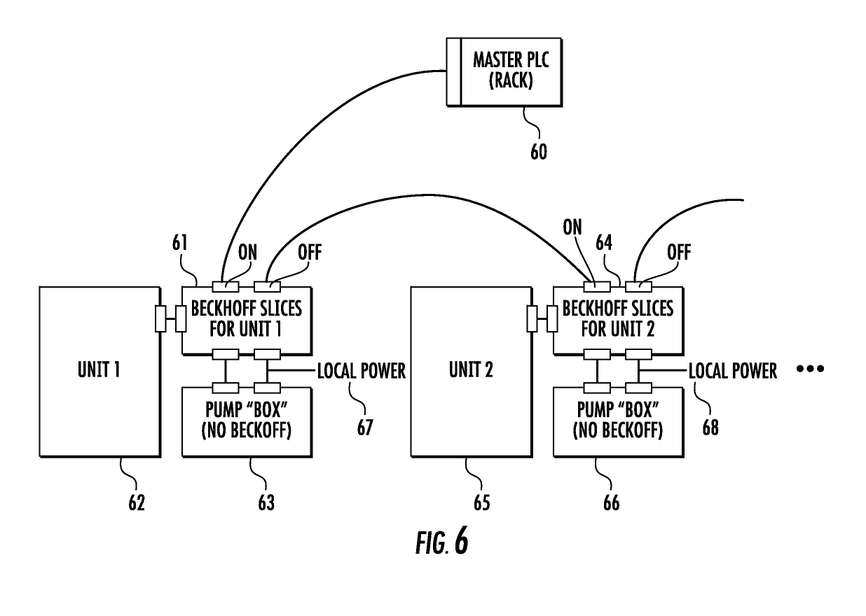

FIG. 7 depicts an embodiment of a liquid dispensing module 70 with an internal liquid reservoir 74. In this embodiment, a plug 73 is included to cap off the internal chamber and reduce dead space. The plug may be bonded in place. Dispensing nozzles 72 are inserted into the device and may be bonded. 71 depicts a mounting feature for an inlet fitting.

FIG. 8 depicts an embodiment of a liquid dispensing module with two inlets, one inlet for reagent and another for addition of a liquid for flushing salt or other unwanted substances from the dispensing nozzles. The first inlet 80 is the main reagent line, and the second inlet 81 is the flush line. By having the second inlet mounted on the dispense manifold itself (as opposed to further upstream), this minimizes the volume of reagent that will be flushed. An optional valve 83 may be placed on the first inlet, the second inlet, or both. The valve may be passive (e.g., check valve) or active (e.g., solenoid valve). The valve(s) prevent passive mixing of the two liquids (reagent and flush liquid) in the dispense manifold body. The valve(s) may be made of metal, or biocompatible plastic, e.g., PEEK.

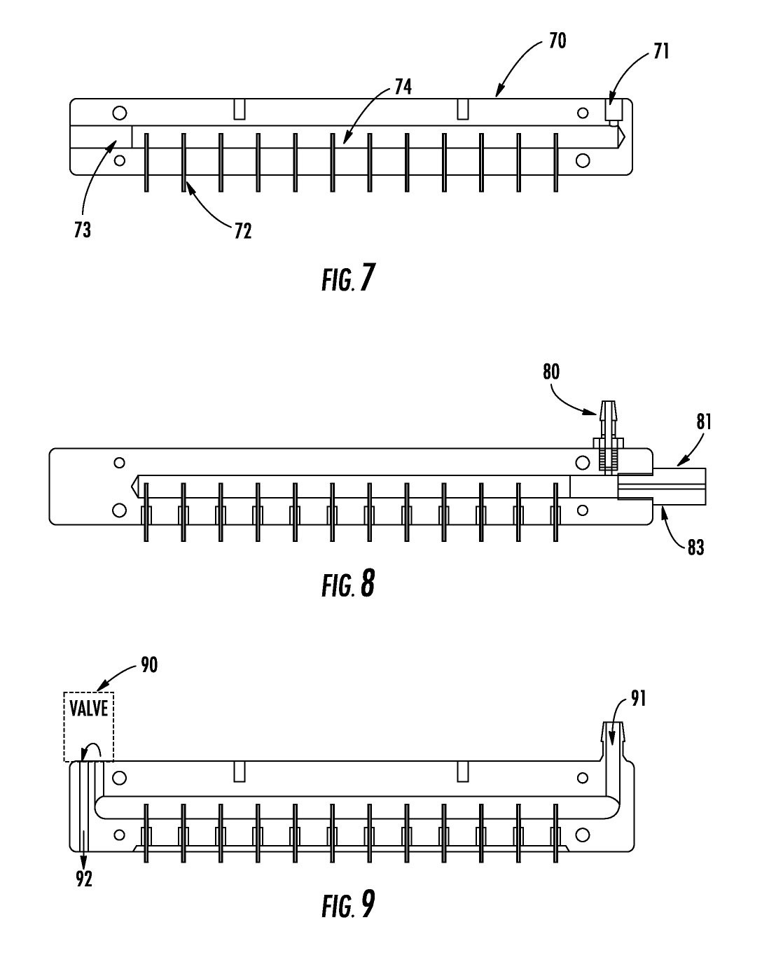

FIG. 9 depicts an embodiment of a liquid dispensing module in which a passive or active valve 90 is placed on the opposite end of the dispensing manifold from the inlet 91. During dispensing operation, the valve is closed (no fluid motion through valve) and the only outlet ports are the dispensing nozzles, aimed at the sample wells. When the valve is opened to allow fluid motion, the valve path exposes a lower resistance path for fluid flow, and the reagent is able to more easily fill the internal liquid reservoir. One important function of this mechanism is to allow a more thorough removal of air pockets in the internal reservoir, which can adversely affect dispensing performance. In some embodiments, an exhaust outlet 92 may be pointed in the same direction as the dispensing nozzles. In some variations, there may be a tubing connection at the exhaust outlet, which redirects the reagent into a waste chamber or back into the reagent source reservoir (i.e., reagent recovery). This is particularly desirable for expensive or low availability reagents. In some variations, a flush valve system may be included, in addition to the exhaust valve system.

FIG. 10 depicts an integrated modular liquid handling system with an optional wash trough (e.g., sonication trough) 100, an embodiment of which is shown in greater detail in FIG. 11. In some embodiments, an ultrasonic motor is in contact with the trough. Modules that come in contact with samples, such as the aspiration modular device, may need to be decontaminated to ensure continued proper functioning. The vertical track may be used to drive a modular device part to be cleaned, such as aspiration tips, into the body of the wash trough for cleaning. The wash trough may be filled with a cleaning solution, for example, a detergent, through ports 110. In some embodiments, the wash trough is filled with a detergent (e.g., Tergazyme™) through fill ports 110, and the device part to be cleaned is dipped into the detergent bath. In the case of aspiration tips, the detergent may be aspirated into the tips. In other embodiments, as the device part to be cleaned, e.g., aspiration tips are being cleaned in the detergent bath, the trough body is agitated with an ultrasonic motor, e.g., a sonication process. This can dislodge contaminants in the physical parts of the modular device, for example, congealed blood in aspiration tips. A sonicating wash trough may cause vibrations that are harmful to a robotic system, e.g., the planar gantry or the vertical track, so a damping mechanism (e.g., grommets, such as rubber grommets) may be employed to mount the sonicating trough to the rest of the robotic frame. In some embodiments, an integrated liquid level sensor is included to detect whether the wash trough is overflowing, for example, with detergent, to prevent inadvertent flooding of the device.

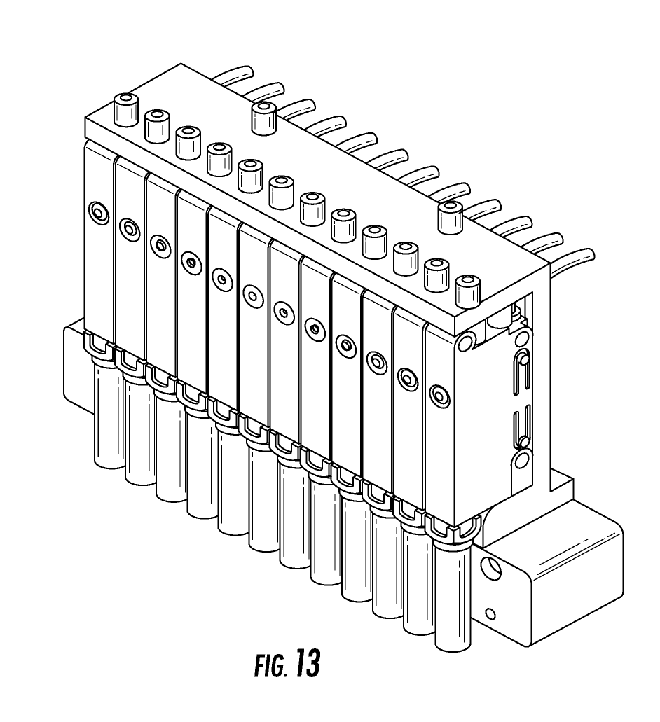

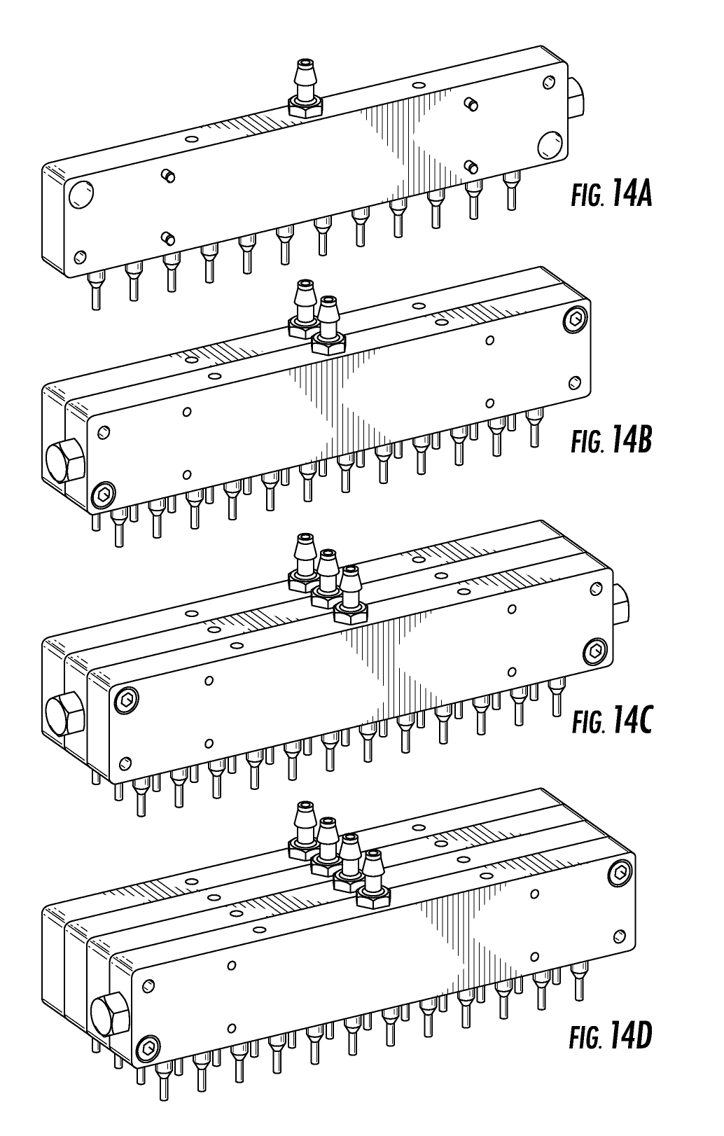

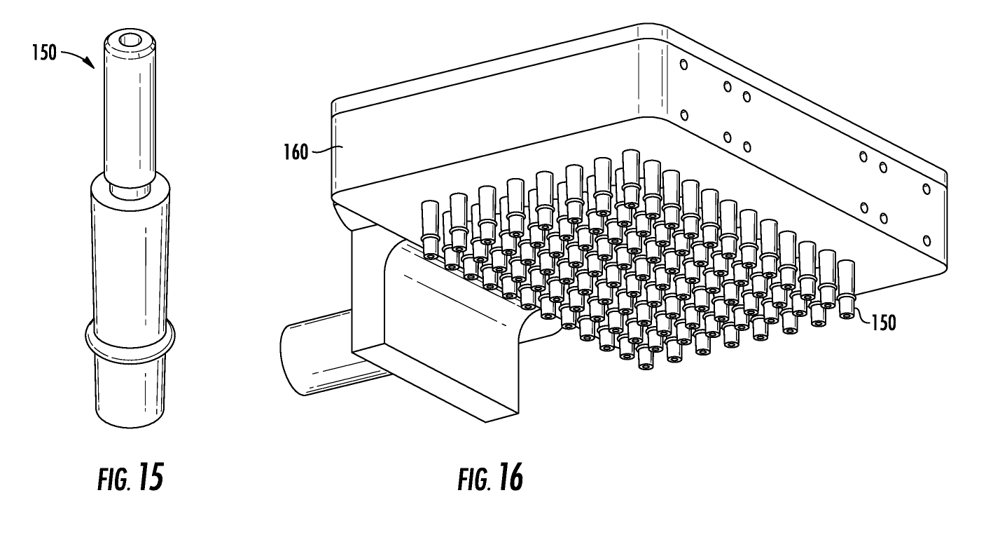

FIGS. 14A-14D show an embodiment of “stackable” liquid dispensing modules connected in series and each configured to dispense liquid to a row of wells in a plate (e.g., 12 wells of a 96-well plate). If eight modules are stacked together, the resulting dispensing module may be configured to dispense liquid to the entire plate of 96 wells. This concept may be adapted to dispense in a format of rows of the plate (e.g., up to 12 rows of 8 wells), or to plates that have different numbers of wells (e.g., 384-well plate). The modules may be stacked to dispense to the entire plate by stacking eight rows of 12 nozzles. Alternately, the manifold could be constructed to correspond to columns (8 nozzles) of a 96-well plate, or could be configured for other plate formats (e.g., 384 wells). The liquid dispensing modules in the “stack” may dispense the same or different liquids to columns or rows of the plate (e.g., may be connected to external liquid reservoir(s) containing the same or different liquid(s).

Although the foregoing invention has been described in some detail by way of illustration and examples for purposes of clarity of understanding, it will be apparent to those skilled in the art that certain changes and modifications may be practiced without departing from the spirit and scope of the invention, which is delineated by the appended claims. Therefore, the description should not be construed as limiting the scope of the invention.

All publications, patents, and patent applications cited herein are hereby incorporated by reference in their entireties for all purposes and to the same extent as if each individual publication, patent, or patent application were specifically and individually indicated to be so incorporated by reference.

We claim:

1. An integrated modular system for liquid handling, comprising:
(a) a robotic system that comprises (i) a platform configured to support a sample processing plate that comprises a plurality of wells or a tube rack that comprises a plurality of sample tubes, wherein the platform is mounted on a planar surface gantry configured for sliding the platform in a substantially horizontal planar direction; (ii) a support for attaching at least one modular device that performs one or more function(s) related to liquid in the wells of the plate or in the sample tubes, wherein the support is mounted on a track configured for sliding the support in a substantially vertical direction; (iii) a mechanism for slidably moving the platform relative to the least one modular device; and (iv) a mechanism for slidably moving the support along the track relative to the platform,
(b) a pumping system for moving liquid into and out of the wells of the plate or into and out of the sample tubes through the at least one modular device; and
(c) a control system for controlling said one or more function(s) related to liquid in the wells of the plate or sample tubes and/or movement of the plate or tube rack relative to said at least one modular device.

2. A system according to claim 1, wherein the robotic system is configurable to comprise a plurality of modular devices, wherein the modular devices perform one or more functions comprising dispensing liquid into wells of a sample processing plate or into sample tubes, transferring samples into wells of a sample processing plate or sample tubes, aspirating liquid out of wells of a sample processing plate or sample tubes, sensing of liquid levels in wells of a sample processing plate or sample tubes, sensing of temperature in wells of a sample processing plate or sample tubes, and/or detection of a signal in wells of a sample processing plate or sample tubes.

3. A system according to claim 1, wherein the control system controls one or more functions comprising controlling liquid movement into and/or out of the wells of a sample processing plate or sample tube, sensing of liquid levels or temperature in the wells of a sample processing plate or sample tube, detection of a signal in the wells of a sample processing plate or sample tubes, and/or movement of a sample processing plate or sample tube rack relative to the at least one modular device.

4. A system according to claim 1, comprising a plurality of modular devices each performing a different function or configured to dispense a different type of liquid into the wells of the plate or into sample tubes.

5. A system according to claim 2, comprising a first modular device is attached to the support and a second modular device fastened to the first modular device, and wherein the planar surface gantry is configured to move relative to the modular devices for performing one or more functions comprising transferring of samples or dispensing of liquid into wells of the plate or into sample tubes, aspiration of liquid out of wells of the plate or out of sample tubes, sensing of liquid levels in wells of the plate or in sample tubes, detection of a signal or temperature in wells of the plate or in sample tubes.

6. A system according to claim 5, comprising a plurality of additional modular devices fastened to the second modular device and to each other in series.

7. A system according to claim 1, wherein wells of the plate or sample tubes comprise samples that are pre-loaded into the wells or tubes prior to addition of the plate or tube rack to the modular system for liquid handling.

8. A system according to claim 7, wherein the at least one modular device is configured to dispense affinity beads in liquid into wells of the plate or into sample tubes, wherein the affinity beads comprise one or more affinity moiety that is capable of binding to a target molecule when present in a sample.

9. A system according to claim 8, wherein the affinity beads are magnetic, and wherein the platform that supports the plate or tube rack comprises one or more magnet that is capable of magnetically attracting the magnetic beads.

10. A system according to claim 1, wherein liquid samples are transferred into wells of the plate or into sample tubes from external sample containers, wherein the at least one modular device comprises a sample transferring module that comprises a pipetting mechanism that is fluidly connected to each sample container, wherein the pumping system is configured to transfer a predetermined amount of liquid sample from each sample container into a well of the plate or into a sample tube.

11. A system according to claim 10, wherein prior to transferring samples into wells of the plate or into sample tubes, the wells or tubes are pre-coated with one or more reagent or affinity moiety that is capable of reacting with or binding to a target molecule when present in a sample.

12. A system according to claim 10, wherein prior to transferring samples into wells of the plate or into sample tubes, the wells or tubes comprise affinity beads that comprise one or more affinity moiety that is capable of binding to a target molecule when present in a sample.

13. A system according to claim 12, wherein the affinity beads are magnetic, and wherein the platform that supports the plate or tube rack comprises one or more magnet that is capable of magnetically attracting the magnetic beads.

14. A system according to claim 1, wherein the at least one modular device comprises a liquid dispensing module, wherein the system further comprises an external liquid reservoir that is fluidly connected to the liquid dispensing module, and wherein the liquid dispensing module is configured for dispensing liquid from the external reservoir into wells of the plate or into sample tubes.

15. A system according to claim 14, wherein the external liquid reservoir is fluidly connected to an internal liquid reservoir within the liquid dispensing module, wherein the pumping system is configured to pump liquid from the external liquid reservoir into the internal liquid reservoir, and wherein a predetermined amount of liquid is pumped from the internal liquid reservoir into wells of the plate or into sample tubes.

16. A system according to claim 15, wherein the liquid dispensing module comprises a plurality of dispensing nozzles that are configured to dispense liquid into wells of the plate or into sample tubes, wherein the dispensing nozzles comprise plastic.

17. A system according to claim 16, wherein the dispensing nozzles consist of plastic.

18. A system according to claim 17, wherein the liquid dispensing module consists of plastic.

19. A system according to claim 16, wherein the plastic comprises polyether ether ketone and/or polycarbonate.

20. A system according to claim 15, wherein the dispensing of liquid into wells of the plate or into sample tubes is contactless.

21. A system according to claim 14, wherein the liquid dispensing module comprises a plurality of dispensing nozzles that are configured to dispense liquid into wells of the plate or into sample tubes, wherein the liquid dispensing module is fluidly connected to at least a first liquid reservoir and a second liquid reservoir, wherein the first reservoir comprises a reagent for dispensing into wells of the plate or into sample tubes and the second liquid reservoir comprises water or a solvent for removing salt or other unwanted substances from the nozzles of the dispensing module when the liquid in the second liquid reservoir is dispensed through the nozzles.

22. A system according to claim 21, wherein the liquid dispensing module is fluidly connected to a waste disposal system, and wherein liquid from the second external liquid reservoir that is dispensed through the nozzles of the dispensing module is conducted to the waste disposal system.

23. A system according to claim 14, wherein the system comprises a plurality of first external liquid reservoirs that comprise different liquids and a plurality of liquid dispensing modules, wherein each first external liquid reservoir is fluidly connected to a different liquid dispensing module.

24. A system according to claim 23, wherein at least one of said liquids comprises affinity beads, wherein the affinity beads comprise one or more affinity moiety that is capable of binding to a target molecule when present in a sample.

25. A system according to claim 24, wherein the affinity beads are magnetic, and wherein the platform that supports the plate or tube rack comprises one or more magnet that is capable of magnetically attracting the magnetic beads.

26. A system according to claim 23, wherein at least one of said plurality of liquid dispensing modules is fluidly connected to a second external liquid reservoir, wherein said first external liquid reservoir comprises a reagent for dispensing into wells of the plate or into sample tubes and the second external liquid reservoir comprises water or a solvent for removing salt or other unwanted substances from the nozzles of the dispensing module when the liquid in the second external liquid reservoir is dispensed through the nozzles.

27. A system according to claim 1, wherein the at least one modular device comprises at least one aspiration module that is configured to remove liquid from the wells of the plate or from the sample tubes.

28. A system according to claim 27, wherein the aspiration module comprises a plurality of aspiration nozzles, wherein each nozzle is configured to aspirate liquid from a well of the plate or from a sample tube.

29. A system according to claim 28, wherein the aspiration nozzles are configured to hold disposable aspirator tips.

30. A system according to claim 29, wherein the aspiration module comprises a push plate configured to dislodge disposable aspirator tips from the aspiration nozzles.

31. A system according to claim 28, wherein the aspiration module is fluidly connected to a waste disposal system, wherein liquid that is aspirated from the wells of the plate or from the sample tubes is conducted to the waste disposal system.

32. A system according to claim 1, wherein the at least one modular device comprises a least one sensing module.

33. A system according to claim 32, wherein the sensing module comprises a sensor to detect the liquid level in wells of the plate or in sample tubes.

34. A system according to claim 32, wherein the sensing module comprises a sensor to detect temperature in wells of the plate or in sample tubes.

35. A system according to claim 1, wherein the at least one modular device comprises at least one detection module, wherein the detection module is capable of detecting a signal in wells of a sample processing plate or in sample tubes.

36. A system according to claim 35, wherein the signal comprises a light absorbance signal, a fluorescence signal, or a luminescence signal.

37. A system according to claim 1, wherein the at least one modular device comprises a vision system.

38. A system according to claim 1, wherein the at least one modular device comprises at least one liquid dispensing module, at least one aspiration module, and at least one sensing module.

39. A system according to claim 1, wherein the platform that supports the plate comprises one or more functionalities selected from shaking, heating, cooling, and magnetic attraction of magnetic material in wells of the plate or tube rack.

40. A system according to claim 1, wherein the platform that supports the plate comprises a tip-tilt mechanism.

41. A system according to claim 1, wherein the pumping system comprises at least one diaphragm pump.

42. A system according to claim 1, wherein the control system controls the sequencing of functions performed by a plurality of modular devices, comprising transferring of samples into wells of a sample processing plate or into sample tubes, dispensing of liquid into wells of a sample processing plate or sample tubes, aspiration of liquid out of wells of a sample processing plate or sample tubes, sensing of liquid levels in wells of a sample processing plate or sample tubes, sensing of temperature in wells of a sample processing plate or sample tubes, and/or detection of a signal in wells of a sample processing plate or sample tubes.

43. A system according to claim 1, wherein the sample processing plate or tube rack comprises a top and a bottom, wherein the plate or tube rack comprises open spaces between the wells or sample tubes on the bottom of the plate, and wherein the platform comprises a plurality of magnets that are configured to fit into and move up and down from beneath and within the spaces between wells or sample tubes.

44. A system according to claim 43, wherein the wells or sample tubes comprise a magnetic material in liquid that is attracted to the magnets when they are in proximity of the magnetic material.

45. A system according to claim 44, wherein the magnetic material comprises magnetic beads.

46. A system according to claim 44, wherein movement of the magnets in the is controlled by a control system that controls the magnets to concentrate the magnetic material in the wells or sample tubes.

47. A system according to claim 44, wherein movement of the magnets in the is controlled by a control system that controls the magnets to disperse the magnetic material, thereby mixing the liquid in the wells or sample tubes.
